(19) United States
(12) Patent Application Publication
(10) Pub. No.: US 2016/0004300 A1
(43) Pub. Date: Jan. 7, 2016

(54) System, Method, Device and Computer Readable Medium for Use with Virtual Environments

(71) Applicant: PinchVR Inc., Toronto (CA)

(72) Inventor: Milan Baic, Toronto (CA)

(21) Appl. No.: 14/793,467

(22) Filed: Jul. 7, 2015

Related U.S. Application Data
(60) Provisional application No. 62/021,330, filed on Jul. 7, 2014.

(51) Int. Cl. G06F 3/01; G06F 1/16; G06F 3/0484; G06F 3/042; G06F 3/0481; G06F 3/0346

(52) U.S. Cl. CPC G06F 3/011; G06F 3/04815; G06F 3/0346; G06F 3/04845; G06F 3/017; G06F 3/0426; G06F 1/163; G09G 2340/10

(57) ABSTRACT

According to the invention, there is disclosed a system, method, device and computer readable medium for a user to interact with objects in a virtual environment. The invention includes a gesture controller, associated with an aspect of the user, and operative to generate spatial data corresponding to the position of the aspect of the user. A mobile device processor is operative to receive the spatial data of the gesture controller and to automatically process the spatial data to generate a spatial representation in the virtual environment corresponding to the position of the aspect of the user. Thus, the invention is operative to facilitate the user interacting with the objects in the virtual environment using the spatial representation of the gesture controller based on the position of the aspect of the user.

### FIELD OF THE INVENTION

The present invention relates generally to a system, method, device and computer readable medium for use with virtual environments, and more particularly to a system, method, device and computer readable medium for interacting with virtual environments provided by mobile devices.

### BACKGROUND OF THE INVENTION

Mobile devices such as mobile phones, tablet computers, personal media players and the like, are becoming increasingly powerful. However, most methods of interacting with these devices are generally limited to two-dimensional physical contact with the device as it is being held in a user's hand.

Head-mounted devices configured to receive mobile devices and allow the user to view media, including two- and three-dimensional virtual environments, on a private display have been disclosed in the prior art. To date, however, such head-mounted devices have not provided an effective and/or portable means for interacting with objects within these virtual environments, using means for interaction that may not be portable, have limited functionality and/or have limited precision within the interactive environment.

The devices, systems and/or methods of the prior art have not been adapted to solve the one or more of the above-identified problems thus negatively affecting the ability of the user to interact with objects within virtual environments.

What may be needed are systems, methods, devices and/or computer readable media that overcomes one or more of the limitations associated with the prior art. It may be advantageous to provide a system, method, device and/or computer readable medium which is portable, allows for precise interaction with objects in the virtual environment (e.g., “clicking virtual buttons within the environment) and/or facilitates a number of interactive means within the virtual environment (e.g., pinching a virtual object to increase or decrease magnification).

It is an object of the present invention to obviate or mitigate one or more of the aforementioned disadvantages and/or shortcomings associated with the prior art, to provide one of the aforementioned needs or advantages, and/or to achieve one or more of the aforementioned objects of the invention.

### SUMMARY OF THE INVENTION

According to the invention, there is disclosed a system for a user to interact with a virtual environment comprising objects. The system includes a gesture controller, associated with an aspect of the user, and operative to generate spatial data corresponding to the position of the aspect of the user. The system also includes a mobile device which includes a device processor operative to receive the spatial data of the gesture controller and to automatically process the spatial data to generate a spatial representation in the virtual environment corresponding to the position of the aspect of the user. Thus, according to the invention, the system is operative to facilitate the user interacting with the objects in the virtual environment using the spatial representation of the gesture controller based on the position of the aspect of the user.

According to an aspect of one preferred embodiment of the invention, the spatial data may preferably, but need not necessarily, include accelerometer data, gyroscope data, manometer data, vibration data, and/or visual data.

According to an aspect of one preferred embodiment of the invention, the gesture controller may preferably, but need not necessarily, include a lighting element configured to generate the visual data.

According to an aspect of one preferred embodiment of the invention, the lighting element may preferably, but need not necessarily include a horizontal light and a vertical light.

According to an aspect of one preferred embodiment of the invention, the lighting elements are preferably, but need not necessarily, a predetermined colour.

According to an aspect of one preferred embodiment of the invention, the visual data may preferably, but need not necessarily, include one or more input images.

According to an aspect of one preferred embodiment of the invention, the mobile device may preferably, but need not necessarily, further include an optical sensor for receiving the one or more input images.

According to an aspect of one preferred embodiment of the invention, the device processor may preferably, but need not necessarily, be operative to generate one or more processed images by automatically processing the one or more input images using cropping, thresholding, erosion and/or dilation.

According to an aspect of one preferred embodiment of the invention, the device processor may preferably, but need not necessarily, be operative to determine a position of the aspect of the user by identifying the position of the horizontal light using the one or more processed images and determine a position of the spatial representation of the gesture controller within the virtual environment based on the position of the aspect of the user.

According to an aspect of one preferred embodiment of the invention, an enclosure may preferably, but need not necessarily, be included to position the mobile device for viewing by the user.

According to an aspect of one preferred embodiment of the invention, four gesture controllers may preferably, but need not necessarily, be used.

According to an aspect of one preferred embodiment of the invention, two gesture controllers may preferably, but need not necessarily, be used.

According to an aspect of one preferred embodiment of the invention, the device processor may preferably, but need not necessarily, be operative to facilitate the user interacting with the objects in the virtual environment by using the spatial representation of the gesture controller to select objects within the aforesaid virtual environment.

According to an aspect of one preferred embodiment of the invention, the device processor may preferably, but need not necessarily, be operative to determine a selection of objects within the aforesaid virtual environment by identifying the status of the vertical light using the one or more processed images.

According to the invention, there is also disclosed a method for a user to interact with a virtual environment comprising objects. The method includes steps (a) and (b). Step (a) involves operating a gesture controller, associated with an aspect of the user, to generate spatial data corresponding to the position of the gesture controller. Step (b) involves operating a device processor of a mobile device to electronically receive the spatial data from the gesture controller and to automatically process the spatial data to generate a spatial representation in the virtual environment corresponding to the position of the aspect of the user. Thus, according to the invention, the method operatively facilitates the user interacting with the objects in the virtual environment using the spatial representation of the gesture controller based on the position of the aspect of the user.

According to an aspect of one preferred embodiment of the invention, in step (a), the spatial data may preferably, but need not necessarily, include accelerometer data, gyroscope data, manometer data, vibration data, and/or visual data.

According to an aspect of one preferred embodiment of the invention, in step (a), the gesture controller may preferably, but need not necessarily, include lighting elements configured to generate the visual data.

According to an aspect of one preferred embodiment of the invention, in step (a), the lighting elements may preferably, but need not necessarily, include a horizontal light and a vertical light.

According to an aspect of one preferred embodiment of the invention, in step (a), the lighting elements may preferably, but need not necessarily, be a predetermined colour.

According to an aspect of one preferred embodiment of the invention, in step (a), the visual data may preferably, but need not necessarily, include one or more input images.

According to an aspect of one preferred embodiment of the invention, in step (b), the mobile device may preferably, but need not necessarily, further include an optical sensor for receiving the one or more input images.

According to an aspect of one preferred embodiment of the invention, in step (b), the device processor may preferably, but need not necessarily, be further operative to generate one or more processed images by automatically processing the one or more input images using a cropping substep, a thresholding substep, an erosion substep and/or a dilation substep.

According to an aspect of one preferred embodiment of the invention, in step (b), the device processor may preferably, but need not necessarily, be operative to (i) determine a position of the aspect of the user by identifying the position of the horizontal light using the one or more processed images, and (ii) determine a position of the spatial representation of the gesture controller within the virtual environment based on the position of the aspect of the user.

According to an aspect of one preferred embodiment of the invention, the method may preferably, but need not necessarily, include a step of positioning the mobile device for viewing by the user using an enclosure.

According to an aspect of one preferred embodiment of the invention, in step (a), four gesture controllers may preferably, but need not necessarily, be used.

According to an aspect of one preferred embodiment of the invention, in step (a), two gesture controllers may preferably, but need not necessarily, be used.

According to an aspect of one preferred embodiment of the invention, the method may preferably, but need not necessarily, include a step of (c) operating the device processor to facilitate the user interacting with the objects in the virtual environment by using the spatial representation of the gesture controller to select objects within the aforesaid virtual environment.

According to an aspect of one preferred embodiment of the invention, in step (c), the selection of objects within the aforesaid virtual environment may preferably, but need not necessarily, be determined by identifying the status of the vertical light using the one or more processed images.

According to the invention, there is disclosed a gesture controller for generating spatial data associated with an aspect of a user. The gesture controller is for use with objects in a virtual environment provided by a mobile device processor. The device processor electronically receives the spatial data from the gesture controller. The gesture controller preferably, but need not necessarily, includes an attachment member to associate the gesture controller with the user. The controller may preferably, but need not necessarily, also include a controller sensor operative to generate the spatial data associated with the aspect of the user. Thus, according to the invention, the gesture controller is operative to facilitate the user interacting with the objects in the virtual environment.

According to an aspect of one preferred embodiment of the invention, the controller sensor may preferably, but need not necessarily, include an accelerometer, a gyroscope, a manometer, a vibration component and/or a lighting element.

According to an aspect of one preferred embodiment of the invention, the controller sensor may preferably, but need not necessarily, be a lighting element configured to generate visual data.

According to an aspect of one preferred embodiment of the invention, the lighting element may preferably, but need not necessarily, include a horizontal light, a vertical light and a central light.

According to an aspect of one preferred embodiment of the invention, the horizontal light, the vertical light and the central light may preferably, but need not necessarily, be arranged in an L-shaped pattern.

According to an aspect of one preferred embodiment of the invention, the lighting elements may preferably, but need not necessarily, be a predetermined colour.

According to an aspect of one preferred embodiment of the invention, the predetermined colour may preferably, but need not necessarily, be red and/or green.

According to an aspect of one preferred embodiment of the invention, the attachment member may preferably, but need not necessarily, be associated with the hands of the user.

According to an aspect of one preferred embodiment of the invention, the attachment member may preferably, but need not necessarily, be elliptical in shape.

According to an aspect of one preferred embodiment of the invention, the attachment member may preferably, but need not necessarily, be shaped like a ring.

According to the invention, there is also disclosed a computer readable medium on which is physically stored executable instructions. The executable instructions are such as to, upon execution, generate a spatial representation in a virtual environment comprising objects using spatial data generated by a gesture controller and corresponding to a position of an aspect of a user. The executable instructions include processor instructions for a device processor to automatically and according to the invention: (a) collect the spatial data generated by the gesture controller; and (b) automatically process the spatial data to generate the spatial representation in the virtual environment corresponding to the position of the aspect of the user. Thus, according to the invention, the computer readable medium operatively facilitates the user interacting with the objects in the virtual environment using the spatial representation of the gesture controller based on the position of the aspect of the user.

Other advantages, features and characteristics of the present invention, as well as methods of operation and functions of the related elements of the system, method, device and computer readable medium, and the combination of steps, parts and economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the system, method, device and computer readable medium according to the present invention, as to their structure, organization, use, and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic diagram of a system and device for use with interactive environments according to one preferred embodiment of the invention;

FIG. 2 is a schematic diagram of components of the system and device of FIG. 1;

FIG. 3 is a schematic diagram depicting an operating platform, including a GUI, according to one preferred embodiment of the invention, shown in use with a device;

FIG. 4 is a perspective view of an enclosure and gesture controllers in accordance with a preferred embodiment of the invention;

FIG. 5 is a perspective view of the gesture controller of FIG. 4 worn on a user's hand in accordance with an embodiment of the invention;

FIGS. 6A-C are side perspectives of the enclosure of FIG. 1 transforming from a non-device loading configuration to a device loading position configuration and FIG. 6D is a plan perspective of the optical component of the enclosure of FIG. 1;

FIGS. 7A and B are the side view and the front view, respectively, of the enclosure of FIG. 1 in a wearable configuration;

FIG. 8 is an enlarged side view of the enclosure of FIG. 1;

FIGS. 9A-C are the back view of the closed enclosure of FIG. 1, the back view of the optical component without a device, and a device respectively;

FIGS. 10A and B are the back view of the closed enclosure of FIG. 9 and the back view of the optical component bearing the device respectively;

FIGS. 11A and B are the front and side views of the enclosure of FIG. 1 worn by a user is;

FIG. 12 is the system of FIG. 1 operated by a user;

FIG. 13 is a front perspective view of an enclosure and gesture controller according to a preferred embodiment of the invention;

FIG. 14 is a back perspective view of the enclosure and gesture controller of FIG. 13;

FIG. 15 is a right side view of the enclosure and gesture controller of FIG. 13;

FIG. 16 is a front view of the enclosure and gesture controller of FIG. 13;

FIG. 17 is a left side view of the enclosure and gesture controller of FIG. 13;

FIG. 18 is a rear view of the enclosure and gesture controller of FIG. 13;

FIG. 19 is a top view of the enclosure and gesture controller of FIG. 13;

FIG. 20 is a bottom view of the enclosure and gesture controller of FIG. 13;

FIG. 21 is a front perspective view of the enclosure of FIG. 13 in a closed configuration;

FIG. 22 is a rear perspective view of the enclosure of FIG. 21;

FIG. 23 is a rear view of the enclosure of FIG. 21;

FIG. 24 is a left side view of the enclosure of FIG. 21;

FIG. 25 is a rear view of the enclosure of FIG. 21;

FIG. 26 is a right side view of the enclosure of FIG. 21;

FIG. 27 is a top view of the enclosure of FIG. 21;

FIG. 28 is a bottom view of the enclosure of FIG. 21;

FIG. 29 is an exploded view of the enclosure and gesture controllers of FIG. 13;

FIG. 30 is an illustration of the system in operation in according to a preferred embodiment of the invention;

FIG. 31 is an illustration of cursor generation in the system of FIG. 30;

FIGS. 32A-E are illustrations of applications for the system of FIG. 30;

FIG. 33 is an illustration of a home screen presented by the GUI and the device of FIG. 2;

FIG. 34 is an illustration of folder selection presented by the GUI and the device of FIG. 2;

FIG. 35 is an illustration of file searching and selection by the GUI and the device of FIG. 2;

FIG. 36 is an illustration of a plan view of the interactive environment according to a preferred embodiment of the invention;

FIG. 37 is an illustration of a social media application by the GUI and the device of FIG. 2;

FIG. 38 is an illustration of folder selection by the GUI and the device of FIG. 2;

FIG. 39 is an illustration of anchor selection for the social media application of FIG. 37;

FIG. 40 is an illustration of the keyboard by the GUI and the device of FIG. 2;

FIG. 41 is an illustration of a video application panel in the interactive environment of FIG. 40;

FIG. 42 is an illustration of video folder selection in the interactive environment of FIG. 38;

FIG. 43 is an illustration of video folder selection and the keyboard in the interactive environment of FIG. 42;

FIG. 44 is an illustration of TV Show folder selection in the interactive environment of FIG. 42;

FIG. 45 is an illustration of TV Show folder selection and the keyboard in the interactive environment of FIG. 44;

FIG. 46 is an illustration of a search application by the GUI and the device of FIG. 2;

FIG. 47 is an illustration of media selection by the GUI and the device of FIG. 2;

FIG. 48 is an illustration of video selection by the GUI and the device of FIG. 2;

FIG. 49 is an illustration of video viewing in the interactive environment according to a preferred embodiment of the invention;

FIG. 50 is an illustration of a text application panel in the interactive environment of FIG. 49;

FIG. 51 is an illustration of video viewing according to a preferred embodiment of the invention;

FIG. 52 is a flow chart of a cursor tracking method according to a preferred embodiment of the invention;

FIG. 53 is an illustration of a cropped and resized input image according to a preferred embodiment of the invention;

FIG. 54 is an illustration of camera blur;

FIGS. 55A and B are illustrations of an input image and a thresholded image, respectively, according to a preferred embodiment of the invention;

FIG. 56 is an illustration of lighting elements according to a preferred embodiment of the invention;

FIGS. 57A-C are illustrations of a thresholded image before application of the erosion substep, after application of the erosion substep, and after application of the dilation substep respectively, in accordance with a preferred embodiment of the invention;

FIG. 58 is an enlarged illustration of the lighting elements of FIG. 56;

FIG. 59 is an illustration of an optimized search rectangle;

FIG. 60 is front perspective view of the enclosure and gesture controllers of FIG. 13 in operation;

FIG. 61 is an illustration of the keyboard and cursors according to a preferred embodiment of the invention;

FIG. 62 is an illustration of the keyboard and cursors of FIG. 61 used with a third party search application;

FIG. 63 is an illustration of the keyboard and cursors of FIG. 61 used with a third party map application;

FIG. 64 is an illustration of the keyboard and cursors of FIG. 61 used with a third party paint application;

FIG. 65 is an illustration of the keyboard and cursors of FIG. 61 used with a third party email application;

FIG. 66 is an illustration of the keyboard and cursors of FIG. 61 used with multiple third party applications; and

FIG. 67 is an illustration of the gesture controller worn on the thumbs of a user.

### DETAILED DESCRIPTION OF THE PREFERRED EMBODIMENTS

The description that follows, and the embodiments described therein, is provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated in order to more clearly depict certain embodiments and features of the invention.

In this disclosure, a number of terms and abbreviations are used. The following definitions of such terms and abbreviations are provided.

As used herein, a person skilled in the relevant art may generally understand the term “comprising” to generally mean the presence of the stated features, integers, steps, or components as referred to in the claims, but that it does not preclude the presence or addition of one or more other features, integers, steps, components or groups thereof.

In the description and drawings herein, and unless noted otherwise, the terms “vertical”, “lateral” and “horizontal”, are generally references to a Cartesian co-ordinate system in which the vertical direction generally extends in an “up and down” orientation from bottom to top (y-axis) while the lateral direction generally extends in a “left to right” or “side to side” orientation (x-axis). In addition, the horizontal direction extends in a “front to back” orientation and can extend in an orientation that may extend out from or into the page (z-axis).

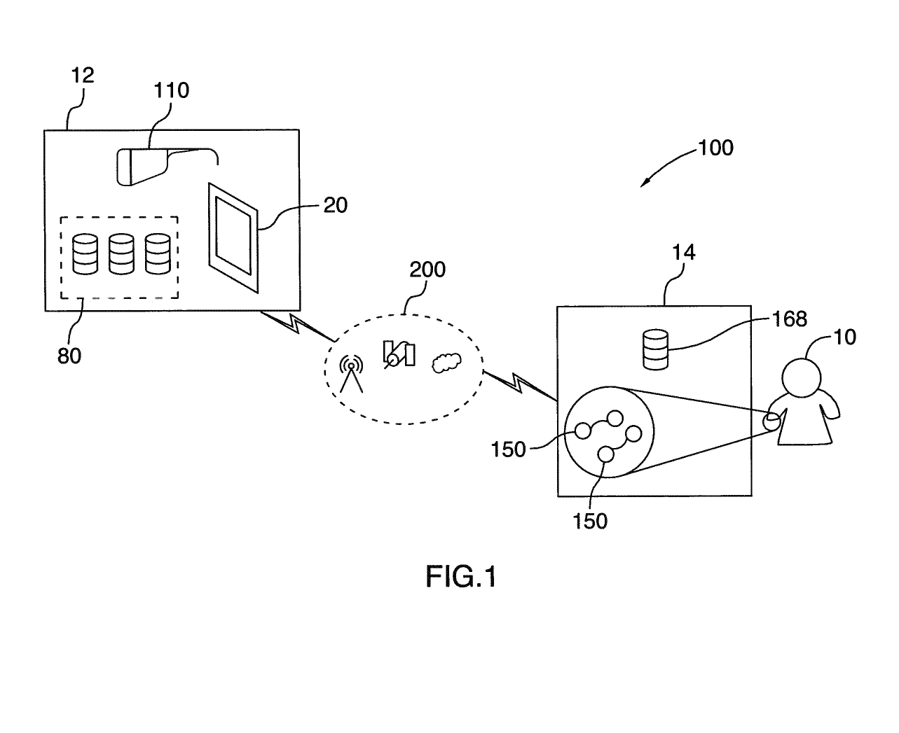

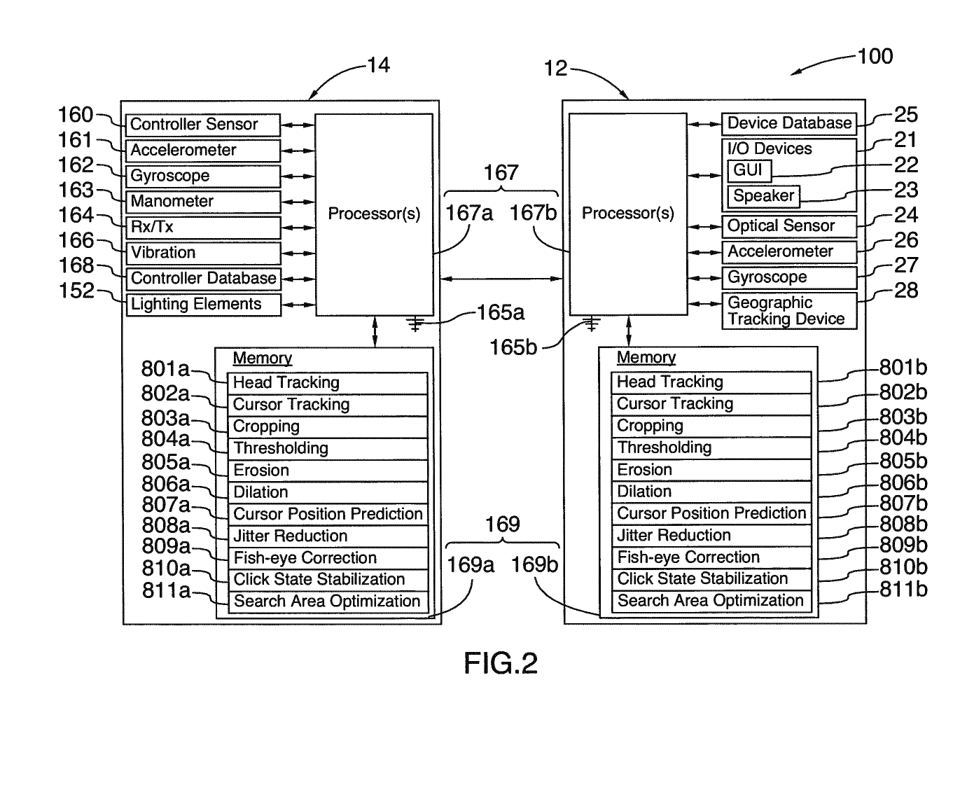

Referring to FIGS. 1 and 2, there is shown a system 100 for use with a mobile device 20 and an enclosure 110 configured to receive the mobile device 20. Preferably, and as best seen in FIG. 1, the system 100 includes a mobile device subsystem 12 and a controller subsystem 14 with one or more gesture controllers 150 associated with a user 10. The device subsystem 12 may preferably include a remote database 80.

In FIGS. 1 and 2, the system 100 is shown in use with a communication network 200. The communication network 200 may include satellite networks, terrestrial wired or wireless networks, including, for example, the Internet. The communication of data between the controller subsystem 14 and the mobile device subsystem 12 may be one or more wireless technology (e.g., Bluetooth™) or may also be achieved by one or more wired means of transmission (e.g., connecting the controllers 150 to the mobile device 20 using a Universal Serial Bus cable, etc.). Persons having ordinary skill in the art will appreciate that the system 100 includes hardware and software.

FIG. 2 schematically illustrates, among other things, that the controller subsystem 14 preferably includes a controller processor 167a, a controller sensor 160, an accelerometer 161, a gyroscope 162, a manometer 163, a receiver-transmitter 164, a vibration module 166, a controller database 168, lighting element(s) 152 and a computer readable medium (e.g., an onboard controller processor-readable memory) 169a local to the controller processor 167a. The mobile device subsystem 12 includes a device processor 167b, a device database 25, input-output devices 21 (e.g., a graphical user interface 22 for displaying an virtual environment 56 (alternately platform graphical user interface 56) for the user, a speaker 23 for audio output, etc.), an optical sensor 24, an accelerometer 26, a gyroscope 27, a geographic tracking device 28 and a computer readable medium (e.g., a processor-readable memory) 169b local to the device processor 167b.

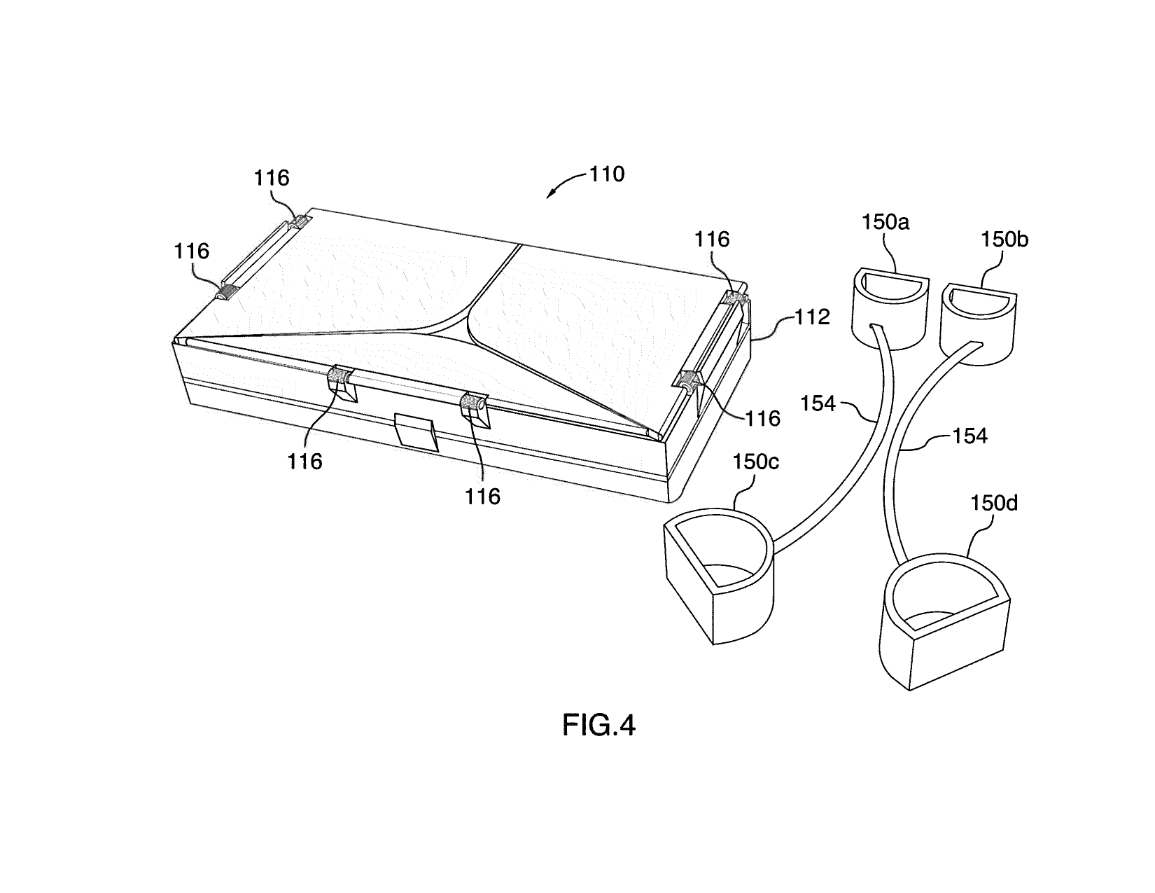

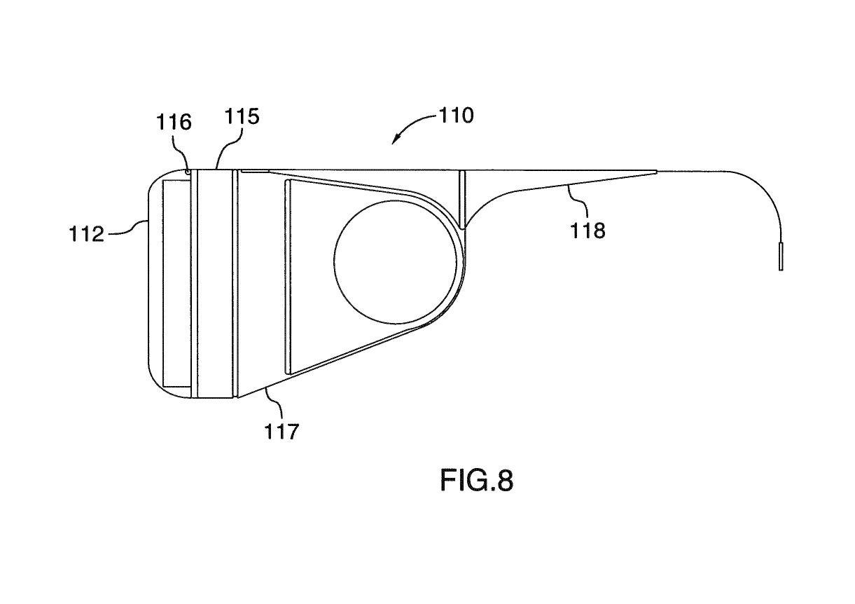

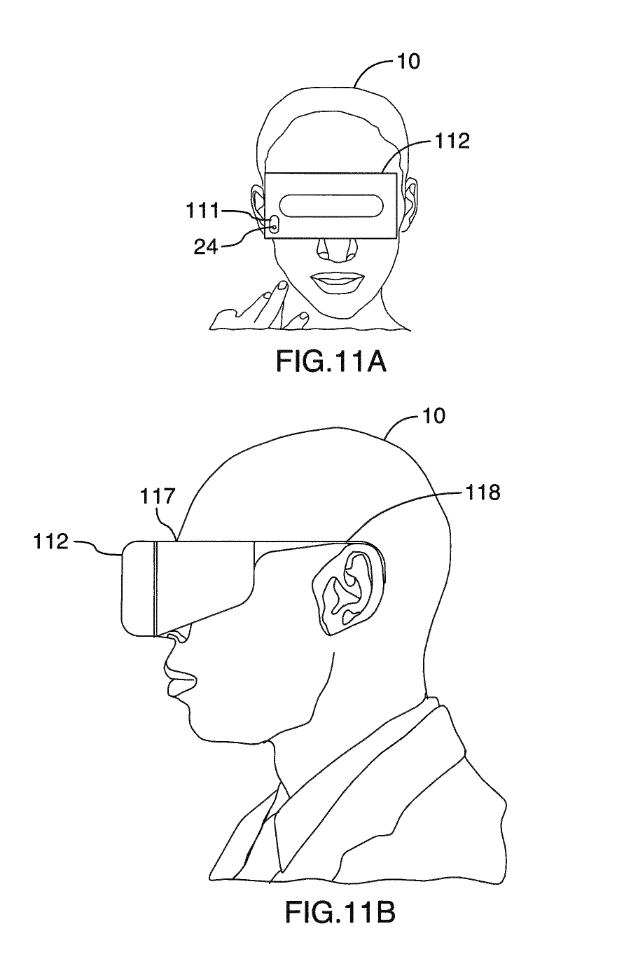

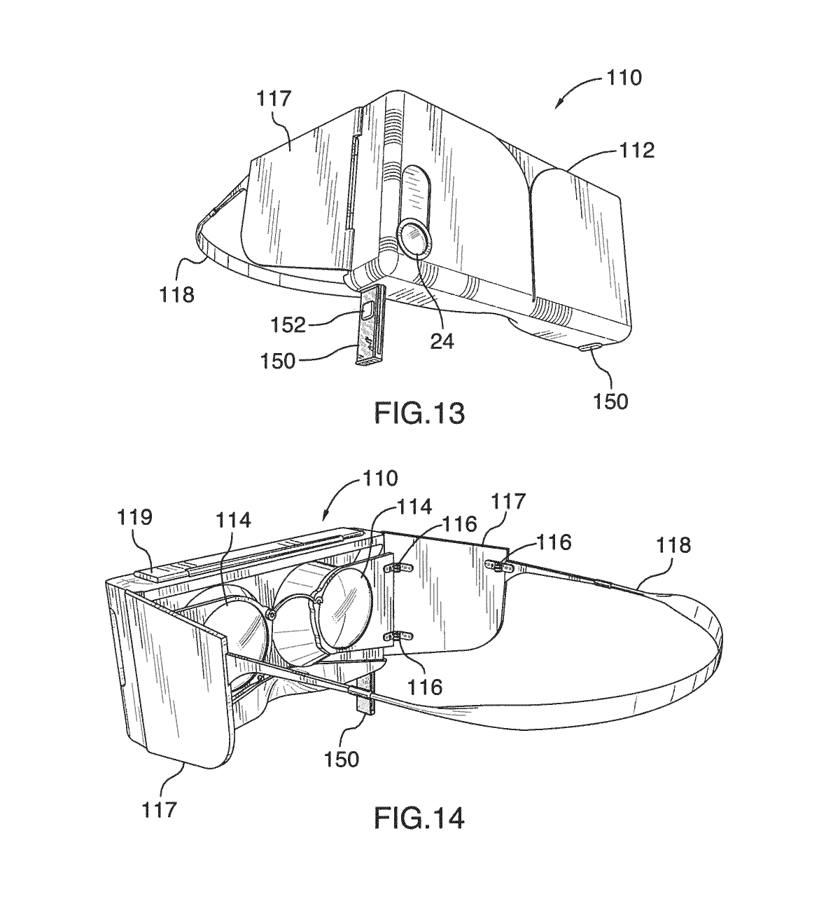

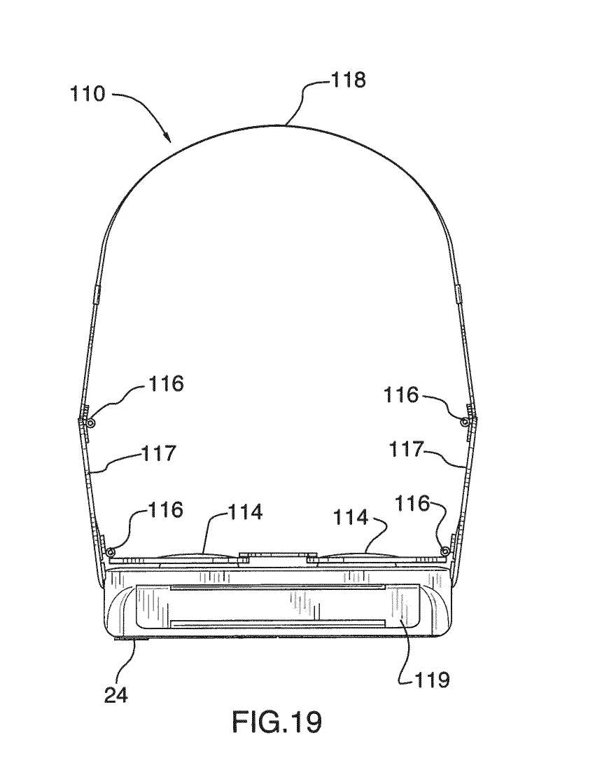

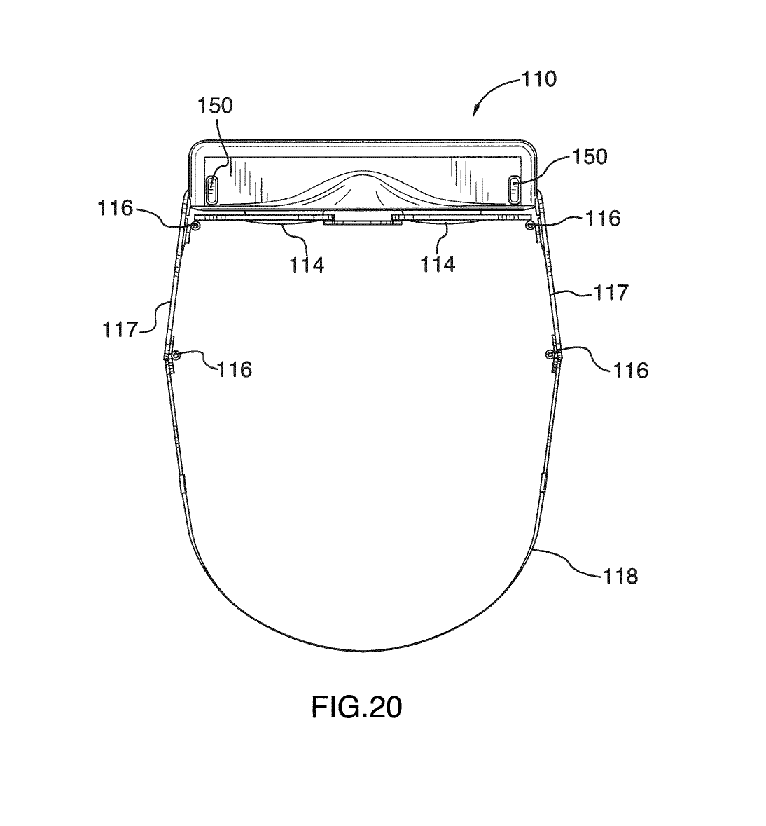

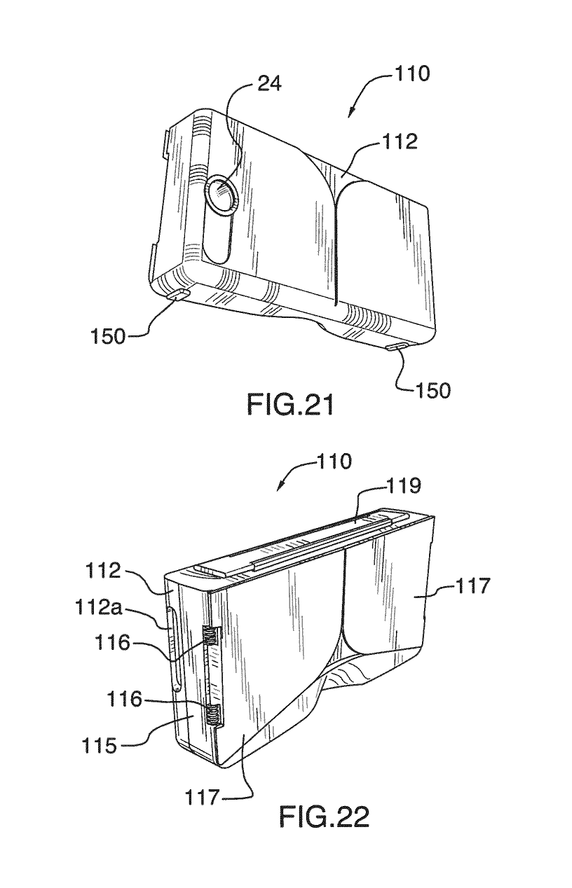

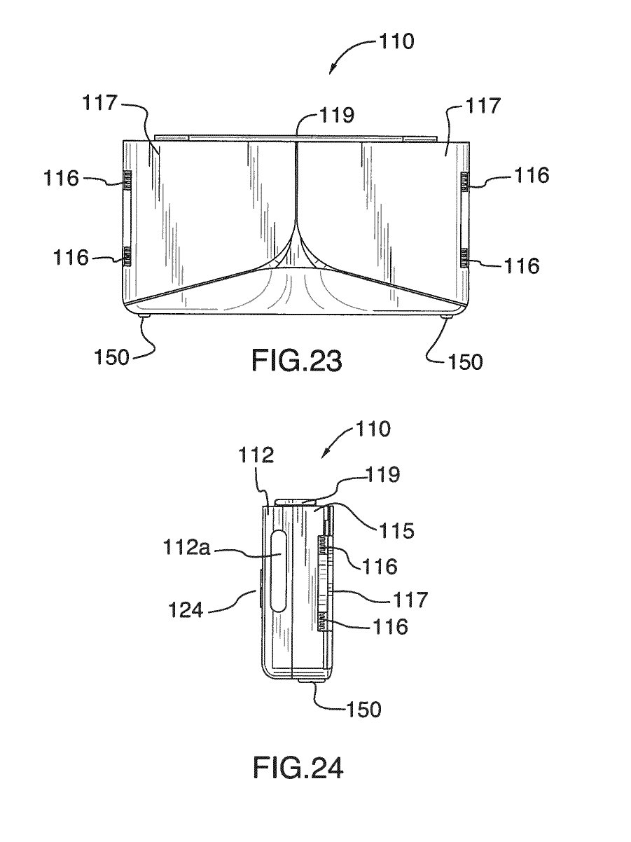

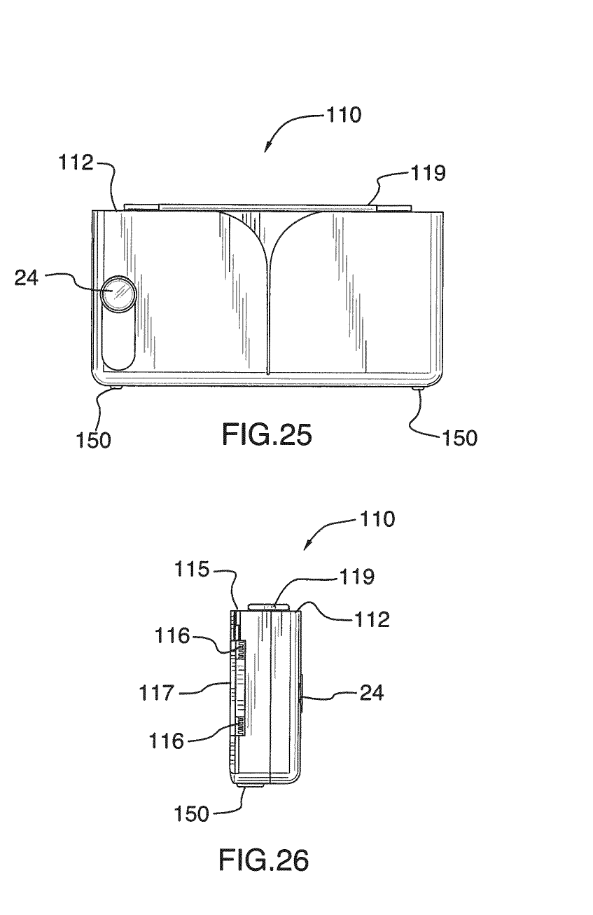

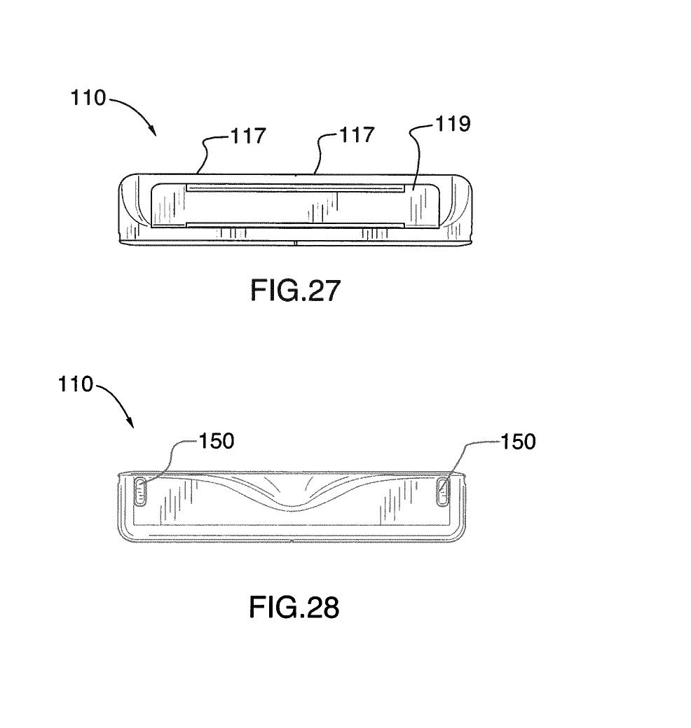

Referring to FIGS. 4-11 and 13-29, there is depicted an enclosure 110 adapted to be worn on the head of a user 10 and gesture controllers 150a,b,c,d (collectively controllers 150). Preferably, the enclosure 110 comprises a housing 112 configured for receiving a mobile device 20 so as to face the eyes of the user 10 when the enclosure 110 is worn by the user 10 (see, for example, FIG. 11). The enclosure 110 preferably comprises shades 117 to reduce ambient light when the enclosure 110 is worn by the user and a fastener 118 to secure the position of the enclosure 110 to the head of the user 10. The fastener 118 may comprise hooks that fit around the ears of the user 10 to secure the position of the enclosure 110. Alternatively, the fastener 118 may comprise a band (preferably resilient) that fits around the head of the user 10 to secure the position of the enclosure 110 (as seen in FIGS. 13-29). While the enclosure 110 depicted in the figures resemble goggles or glasses, persons skilled in the art will understand that the enclosure 110 can be any configuration which supports the mobile device 20 proximal to the face of the user 10 such that a graphical user interface (GUI) 22 of the mobile device 20 can be seen by the user 10.

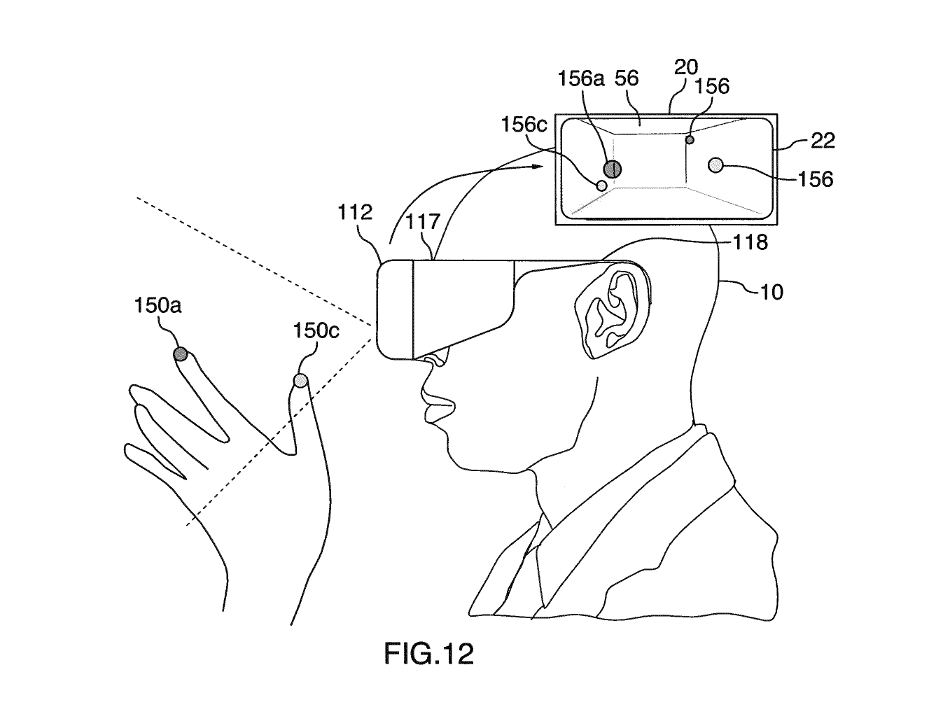

Preferably, the enclosure 110 is foldable, as shown in FIGS. 4, 6, 9, 10 and 21-28. In some preferable embodiments the enclosure 110 may also function as a case for the mobile device 20 when not worn on the head of the user 10. In preferable embodiments, the mobile device 20 will not have to be removed from the enclosure 110 for use in an interactive environment mode (as depicted in FIG. 12) or in a traditional handheld mode of operation (not shown).

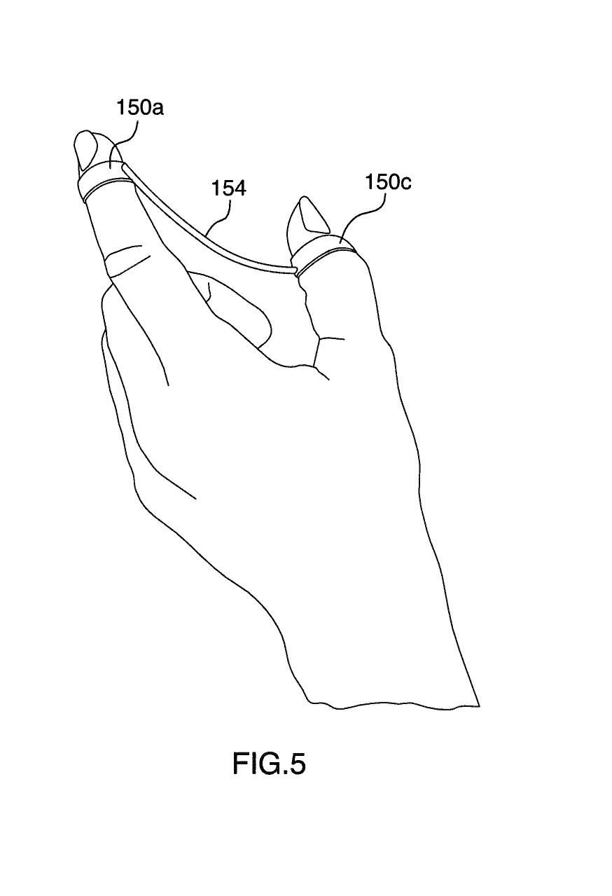

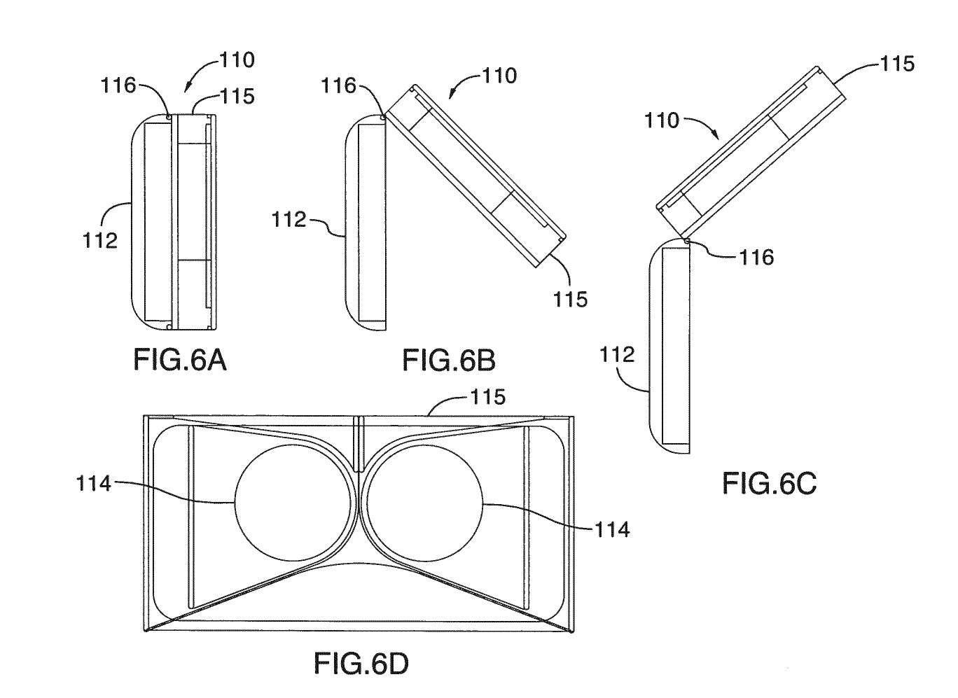

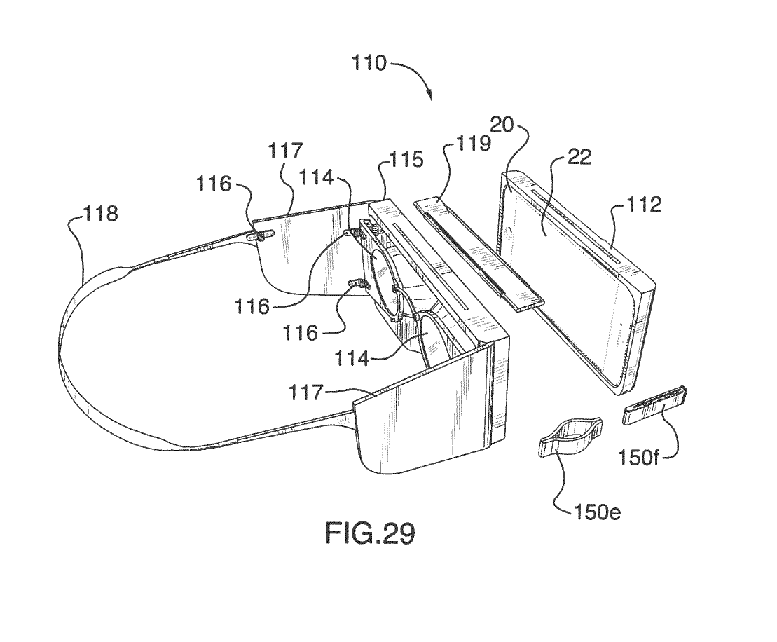

In one embodiment, the mobile device 20 may be loaded or unloaded from the enclosure 110 by pivoting an optical component 115 (described below) to access the housing 112, as depicted in FIGS. 6A-C. In another embodiment, the housing 112 can be accessed by separating it from the optical component 115; the housing 112 and optical component 115 connected by a removable locking member 119 as shown, for example, in FIG. 29.

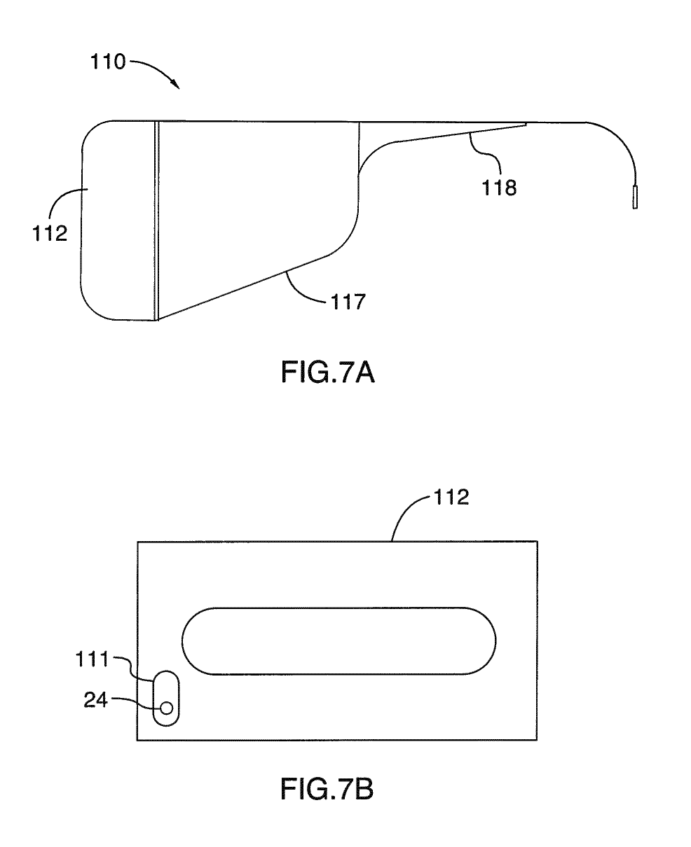

In some preferable embodiments, the enclosure 110 is plastic or any single or combination of suitable materials known to persons skilled in the art. The enclosure 110 may include hinges 116, or other rotatable parts know to persons of skill in the art, to preferably facilitate the conversion of the enclosure 110 from a wearable form (as shown in FIGS. 7A, 8 and 11-20) to an enclosure 110 that can be handheld (as shown in FIGS. 4, 6A and 21-28). In some preferable embodiments, the dimensions of the enclosure 110 are less than 6.5×15×2.5 cm (length×width×depth respectively).

Preferably, referring to 6D, 9B, 10B, 14, 18 and 29, the enclosure 110 includes an optical component 115 comprising asymmetrical lenses 114 (e.g., the circular arcs forming either side of the lens have unequal radii) to assist the eyes of the user 10 to focus on the GUI 22 at close distances. Preferably, the lenses 114 may also assist in focusing each eye on a different portion of the GUI 22 such that the two views can be displayed on the different portions to simulate spatial depth (i.e., three dimensions). In preferable embodiments, the lenses 114 are aspherical to facilitate a “virtual reality” effect.

In preferred embodiments, the enclosure 110 includes one or more enclosure lenses 111 (shown in FIG. 7B) for positioning over or otherwise in front of an optical sensor 24 of the mobile device 20. Preferably, the enclosure lens 111 is a wide angle (or alternatively a fish eye) lens for expanding or otherwise adjusting the field of view of the optical sensor 24. Preferably, the lens 111 for expands the field of view of the mobile device 20 and may improve the ability of the device 20 to detect the gesture controllers 150 (as best seen in FIG. 12) particularly, for example, when the hands of the user 10 are further apart with respect to the field of view of the optical sensor 24 of the mobile device 20.

Preferably, the enclosure 110 includes one or more filters 113 (not shown). The filter(s) 113 preferably filters wavelengths of the electromagnetic spectrum and may preferably comprise a coating on the enclosure 110 or lens 111, or can include a separate lens or optical component (not shown). In some preferable embodiments, the filter(s) 113 are configured to allow a predetermined range of wavelengths of the electromagnetic spectrum to reach the optical sensor 24, while filtering out undesired wavelengths.

In some preferable embodiments, the filter(s) 113 are configured to correspond to wavelength(s) emitted by the lighting element(s) 152 of the controllers 150. For example, if the lighting element(s) 152 emit green light (corresponding to wavelength range of approximately 495-570 nm), the filter(s) 113 may be configured to permit wavelengths corresponding to green light to pass through the filter(s) 113 while filtering out wavelengths that do not correspond to green light. In some preferable embodiments, filtering undesired wavelengths can reduce or otherwise simplify the cursor tracking process 300 by the mobile device 20.

In preferable embodiments, the lighting element(s) 152 are configured to emit ultraviolet light, and the filter(s) 113 can be configured to filter wavelengths falling outside the range emitted by the lighting elements 152. Preferably, the use of ultraviolet light facilitates the reduction in interference and/or false positives that may be caused by background lighting and/or other light sources in the visible spectrum. Preferably, the use of ultraviolet light may also reduce the ability of a third party to observe the actions being taken by the user 10 wearing the enclosure 110 and using the lighting elements 152.

Gesture Controllers

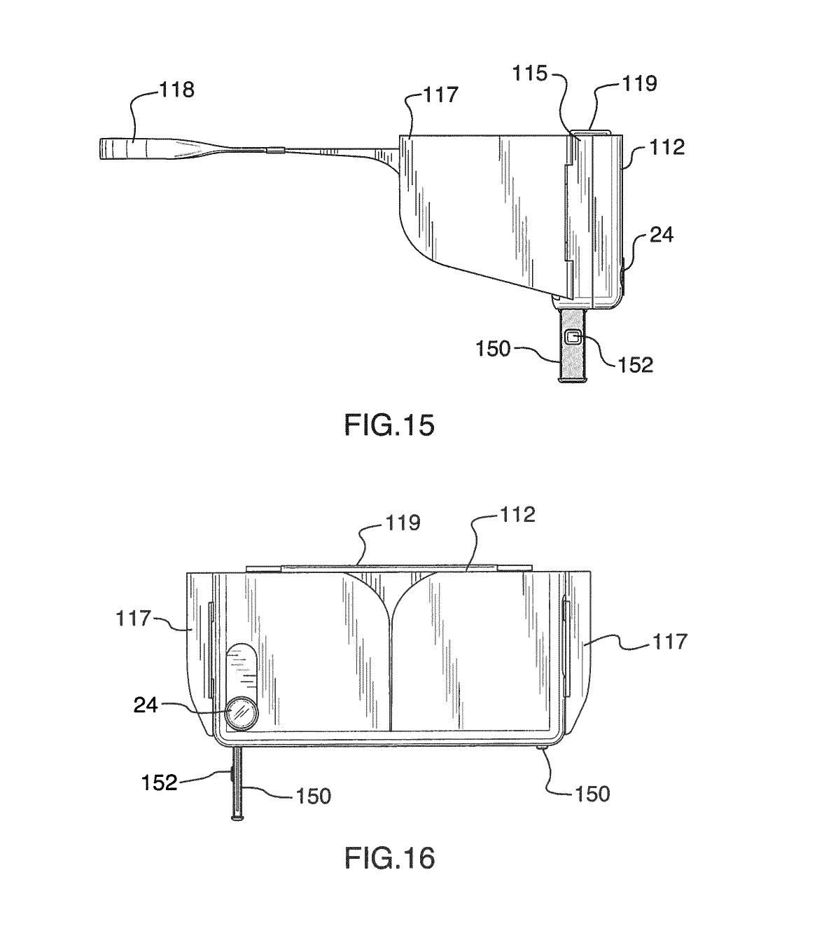

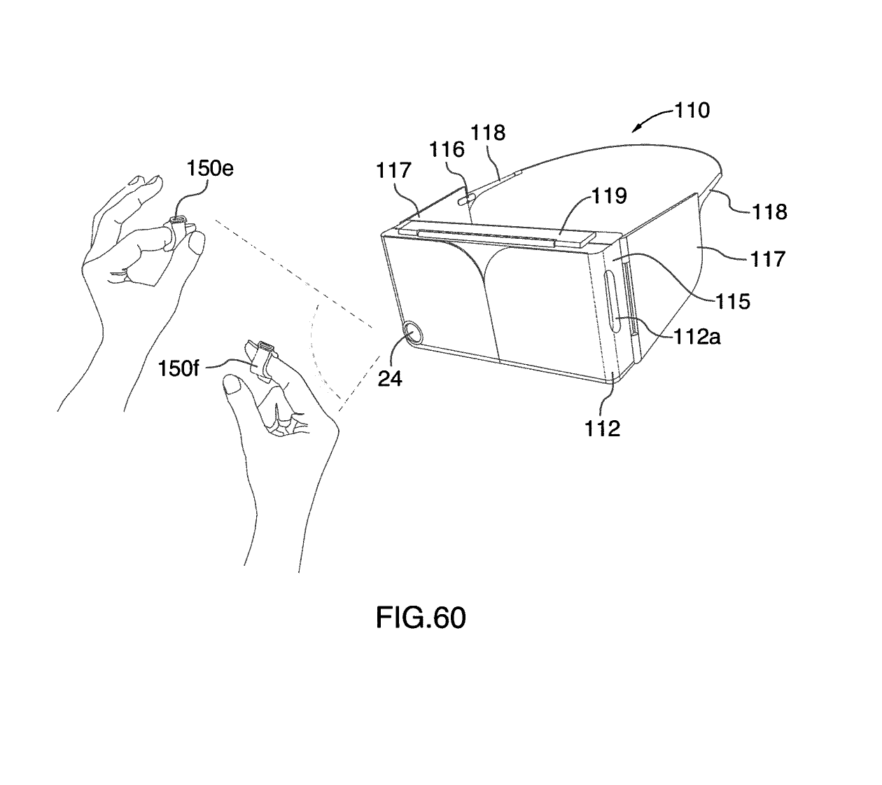

As depicted in FIGS. 4, 5 and 30, in preferable embodiments, the system 100 includes four gesture controllers 150a,b,c,d which can be worn on the hands of the user 10. Preferably, the gesture controllers 150a,b,c,d operate in pairs (e.g., 150a,b and 150c,d); each pair may be connected by a flexible wire 154. In other embodiments, the gesture controllers 150a,b,c,d can operate independently and/or may not be physically connected to its pair or other the controller 150. Persons skilled in the art will appreciate that a user 10 can use more or less than four gesture controllers 150a,b,c,d with the system 100. As shown in FIGS. 29 and 60, for example, the system 100 may preferably be used with two gesture controllers 150e,f. As best shown in FIGS. 15, 17, 24 and 26, in some preferable embodiments, the optical component 115 may define a cavity (e.g., along the bottom of the component 115) to store the gesture controllers 150e,f. In an alternate embodiment, the optical component 115 may define a cavity along a side portion to store the gesture controllers 150e,f (not shown).

In some preferable embodiments, as best shown in FIG. 2, each controller 150a,b,c,d,e,f (collectively controller 150) can include controller sensors 160 (such as, but not limited to microelectromechanical system (or MEMs) devices) such as an accelerometer 161, a gyroscope 162, a manometer 163, a vibration module 166 and/or lighting elements 152 (alternately light emitting elements 152) for detecting accelerometer, gyroscope, manometer, vibration, and/or visual data respectively—collectively, the spatial data 170. Persons skilled in the art may understand that visual data includes both visual and non-visual light on the electromagnetic spectrum. The gesture controller(s) 150 may also include a receiver-transmitter 164 and/or a controller database 168. Using the receiver-transmitter 164, the controller processor(s) 167a may be wired to communicate with—or may wirelessly communicate via the communication network 200 (for example, by the Bluetooth™ proprietary open wireless technology standard which is managed by the Bluetooth Special Interest Group of Kirkland, Wash.)—the mobile device processor(s) 167b.

Preferably, the processors 167—i.e., the controller processor(s) 167a and/or the courier processor(s) 167b—are operatively encoded with one or more algorithms 801a, 801b, 802a, 802b, 803a, 803b, 804a, 804b, 805a, 805b, 806a, 806b, 807a, 807b, 808a, 808b, 809a, 809b, 810a, 810b, and/or 811a, 811b (shown schematically in FIG. 2 as being stored in the memory associated with the controller subsystem 14 and/or the device subsystem 12) which provide the processors 167 with head tracking logic 801a, 801b, cursor tracking logic 802a, 802b, cropping logic 803a, 803b, thresholding logic 804a, 804b, erosion logic 805a, 805b, dilation logic 806a, 806b, cursor position prediction logic 807a, 807b, jitter reduction logic 808a, 808b, fish-eye correction logic 809a, 809b, click state stabilization logic 810a, 810b and/or search area optimization logic 811a, 811b. Preferably, the algorithms 801a, 801b, 802a, 802b, 803a, 803b, 804a, 804b, 805a, 805b, 806a, 806b, 807a, 807b, 808a, 808b, 809a, 809b, 810a, 810b, and/or 811a, 811b enable the processors 167 to provide an interactive platform graphical user interface 56 using, at least in part, the spatial data 170. The controller processor(s) 167a and the device processor(s) 167b are also preferably operatively connected to one or more power sources 165a and 165b respectively.

Preferably, the spatial data 170 can be processed and/or converted into three dimensional spatial (e.g. X, Y and Z) coordinates to define a cursor 156a,b,c,d,e,f (alternately a spatial representation 156a,b,c,d,e,f) for each gesture controller 150a,b,c,d,e,f using the cursor tracking process 300 and algorithm 802a,b. In embodiments where two or more gesture controllers 150a,b,c,d are connected by a wire 154 or other physical connector, the connected controllers may share a single power source 165 (such as a battery) and/or a single receiver-transmitter (alternately a communication module) 164 for communicating spatial data 170 from the gesture controller processor(s) 167a to the mobile device processor(s) 167b. Preferably, the sharing of a communication module 164 can reduce the communication and/or energy requirements of the system 100.

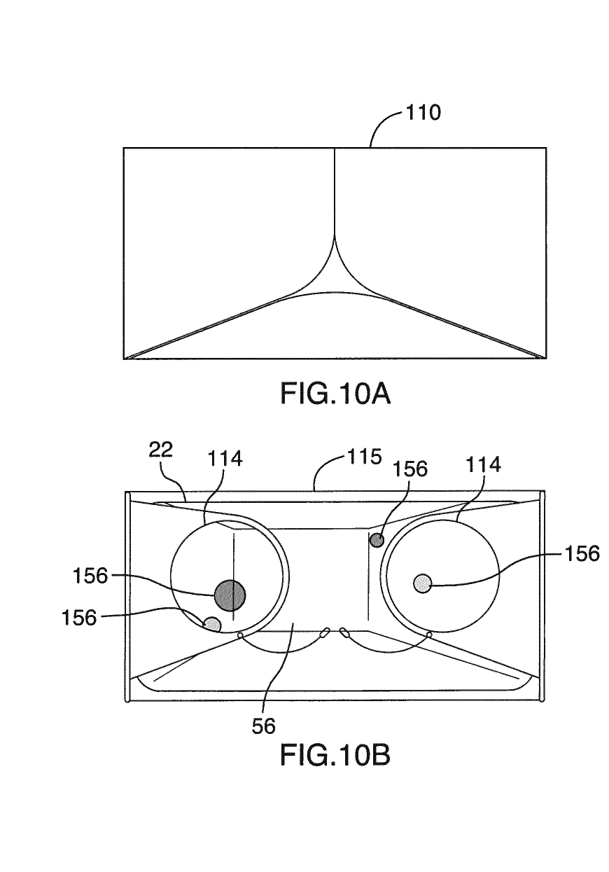

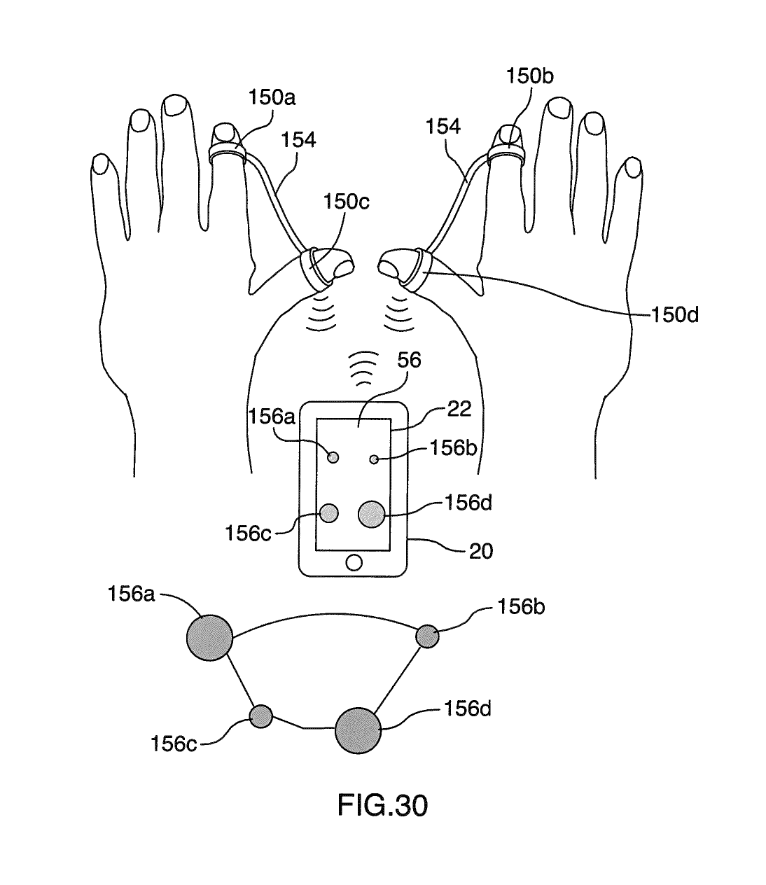

In a preferred embodiment, as shown in FIGS. 10b, 12, 30 and 31, the gesture controllers 150a,b,c,d produce four unique inputs and/or cursors/pointers 156a,b,c,d which can allow the user 10 to interact with an interactive/virtual environment and/or objects within the virtual environment provided by the mobile device processor(s) 167b. For example, as shown in FIG. 30, the cursors 156a,b,c,d may define a parallelogram shape to allow the user 10 to twist and/or contort objects with the virtual environment 56. In some preferable embodiments, the gesture controllers 150a,b,c,d include vibration module(s) 166 for providing tactile feedback to the user 10.

In preferred embodiments, in the four gesture controller 150a,b,c,d configuration, a gesture controller 150a on one hand and/or finger may include: (a) a MEMs sensor 160; (b) a Custom PCB board 167 with a receiver-transmitter 164; (c) a power source 165a; (d) a vibration module 166 for tactile feedback; and/or (e) a gesture controller processor 167a. A gesture controller 150b on the other hand and/or finger may preferably include: (a) a MEMs sensor 160; and/or (b) a vibration module 166 for tactile feedback.

As shown in FIGS. 4, 5, 29 and 30, the gesture controllers 150a,b,c,d comprise an attachment means for associating with the user 10, such as preferably forming the controllers 150a,b,c,d in the shape of an ellipse, a ring or other wearable form for positioning on the index fingers and thumbs of a user 10. In other preferable embodiments, the gesture controllers 150 may be configured for association with various aspects of the user 10, such as to be worn on different points on the hands of the user 10 (not shown) or other body parts of the user 10 (not shown). In some preferable embodiments, more than four gesture controllers 150 can be included in the system 100 for sensing the position of additional points on the body (e.g., each finger) of the user 10 (not shown). In some alternate embodiments, the controllers 150 may be associated with a glove (not shown) worn on the hand of the user 10.

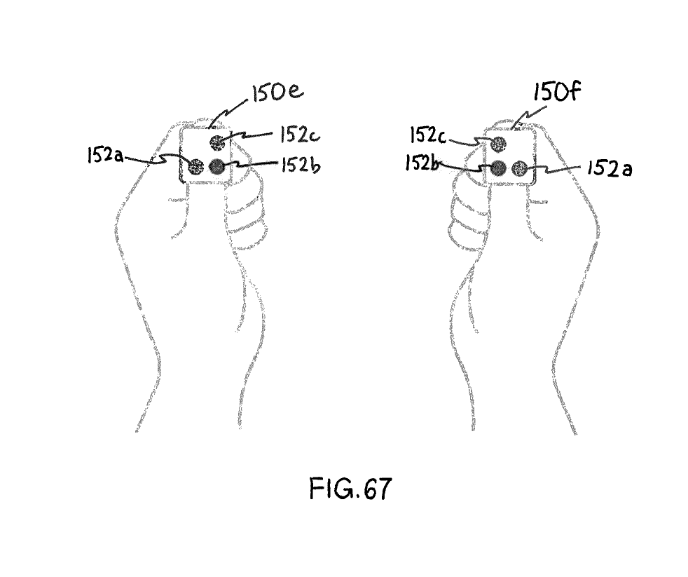

In some preferred embodiments, the gesture controllers 150a,b,c,d can additionally or alternatively be colour-coded or include coloured light emitting elements 152 such as LEDs which may be detected by the optical sensor 24 to allow the device processor(s) 167b to determine the coordinates of the cursors 156a,b,c,d corresponding to each gesture controller 150a,b,c,d. Persons skilled in the art will understand that lighting elements 152 may alternately include coloured paint (i.e., may not be a source of light). In some preferable embodiments, as shown in FIG. 29, the system 100 has two gesture controllers 150e,f worn, for example, on each index finger of the user 10 or each thumb of the user 10 (as shown in FIG. 67). In preferable embodiments, the association of the gesture controllers 150e,f on the thumbs increases the visibility of the lighting elements 152 to the user 10. In some embodiments, the gesture controllers 150 may include any subset or all of the components 152, 160, 161, 162, 163, 164, 165, 166, 167, 168 noted above.

The two gesture controller 150e,f configuration is preferably configured to provide input to the mobile device processor(s) 167b via one or more elements 152 on each of the gesture controllers 150e,f (as best seen, in part, on FIGS. 13 and 15), which are preferably configured to emit a predetermined colour. In some embodiments, use of only the elements 152 as a communication means (e.g., no receiver-transmitter 164 or accelerometer 161) preferably reduces the resource requirements of the system 100. More specifically, in some preferable embodiments, the use of elements 152 only may reduce the power and/or computational usage or processing requirements for the gesture controller processor(s) 167a and/or the mobile device processor(s) 167b. Preferably, lower resource requirements allows the system 100 to be used on a wider range of mobile devices 20 such as devices with lower processing capabilities.

Mobile Device

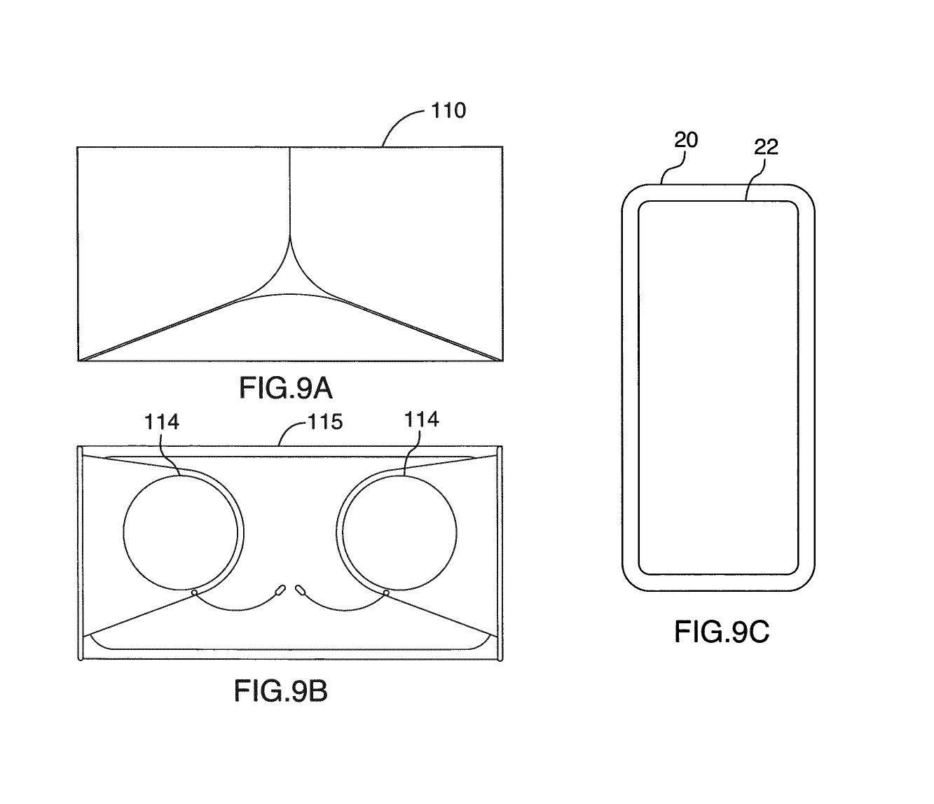

The mobile device 20, as depicted in FIGS. 9C, 12 and 29-31, can be any electronic device suitable for displaying visual information to a user 10 and receiving spatial data 170 from the gesture controller processor(s) 167a. Preferably, the mobile device 20 is a mobile phone, such as an Apple iPhone™ (Cupertino, Calif., United States of America) or device based on Google Android™ (Mountain View, Calif., United States of America), a tablet computer, a personal media player or any other mobile device 20.

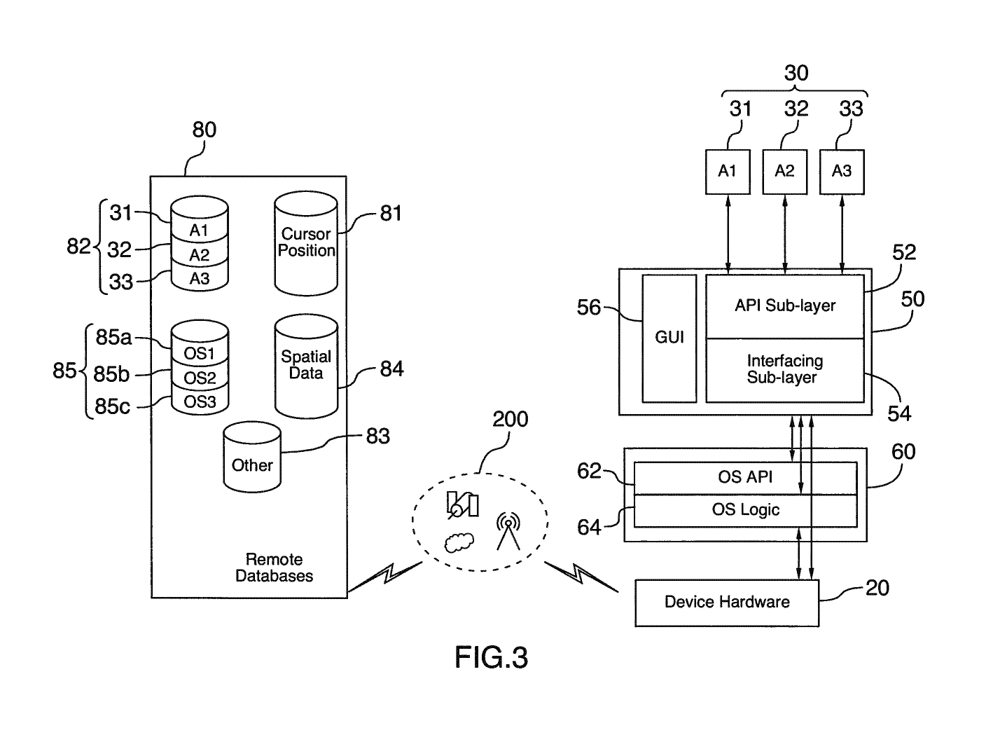

In some preferable embodiments, having regard for FIG. 2, the mobile device can include one or more processor(s) 167b, memory(ies) 169b, device database(s) 25, input-output devices 21, optical sensor(s) 24, accelerometer(s) 26, gyroscope(s) 27 and/or geographic tracking device(s) 28 configured to manage the virtual environment 56. Preferably, the virtual environment 56 can be provided by an operating platform 50, as described in more detail below and with reference to FIG. 3. This operating platform 50 can in some examples be an application operating on a standard iOS™, Android™ or other operating system. In alternative embodiments, the mobile device 20 can have its own operating system on a standalone device or otherwise.

The mobile device 20, as best demonstrated in FIG. 2, preferably includes sensors (e.g., MEMs sensors) for detecting lateral movement and rotation of the device 20, such that when worn with the enclosure 110, the device 20 can detect the head movements of the user 10 in three-dimensional space (e.g., rotation, z-axis or depth movement, y-axis or vertical movement and x-axis or horizontal movement). Such sensors preferably include one or more of optical sensor(s) 24, accelerometer(s) 26, gyroscope(s) 27 and/or geographic tracking device(s) 28.

The mobile device 20 preferably includes a device GUI 22 such as an LED or LCD screen, and can be configured to render a three dimensional interface in a dual screen view that splits the GUI 22 into two views, one for each eye of the user 10, to simulate spatial depth using any method of the prior art that may be known to persons of skill in the art.

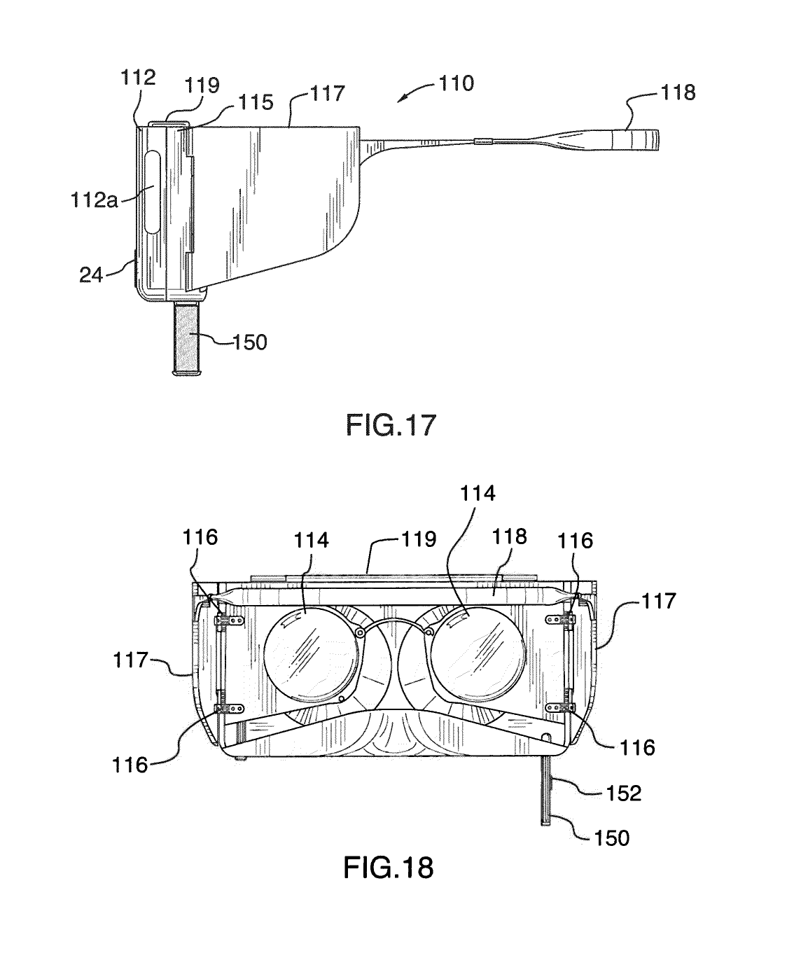

The mobile device 20 can include audio input and/or output devices 23. Preferable, as shown for example in FIGS. 17, 22, 24 and 60, the housing 112 defines a port 112a to allow access to inputs provided by the device 20 (e.g., earphone jack, input(s) for charging the device and/or connecting to other devices).

Operating Platform

The system, method, device and computer readable medium according to the invention may preferably be operating system agnostic, in the sense that it may preferably be capable of use—and/or may enable or facilitate the ready use of third party applications—in association with a wide variety of different: (a) media; and/or (b) device operating systems.

The systems, methods, devices and computer readable media provided according to the invention may incorporate, integrate or be for use with mobile devices and/or operating systems on mobile devices. Indeed, as previously indicated, the present invention is operating system agnostic. Accordingly, devices such as mobile communications devices (e.g., cellphones) and tablets may be used.

Referring to FIG. 3, there is generally depicted a schematic representation of a system 100 according to a preferred embodiment of the present invention. The system 100 preferably enables and/or facilitates the execution of applications (A1, A2, A3) 31, 32, 33 (alternately, referenced by “30”) associated with interactive and/or virtual environments.

FIG. 3 depicts an overarching layer of software code (alternately referred to herein as the “Operating Platform”) 50 which may be preferably provided in conjunction with the system 100 according to the invention. The platform 50 is shown functionally interposed between the underlying device operating system 60 (and its application programming interface, or “API” 62) and various applications 30 which may be coded therefor. The platform 50 is shown to include: the API sub-layer 52 to communicate with the applications 30; the interfacing sub-layer 54 to communicate with the device and its operating system 60; and the platform graphical user interface (alternately virtual environment) 56 which is presented to a user following the start-up of the device, and through which the user's interactions with the applications 30, the device, and its operating system 60 are preferably mediated.

In FIG. 3, the platform 50 is shown to intermediate communications between the various applications 30 and the device operating system (“OS”) 60. The system 100 preferably enables and/or facilitates the execution of the applications 30 (including third party applications) coded for use in conjunction with a particular operating system 85a-c on devices provided with a different underlying operating system (e.g., the device OS 60). In this regard, and according to some preferred embodiments of the invention, the API sub-layer 52 may be provided with an ability to interface with applications 30 coded for use in conjunction with a first operating system (OS1) 85a, while the interfacing sub-layer 54 may be provided with an ability to interface with a second one (OS2) 85b. The API 52 and interfacing sub-layers 54 may be supplied with such abilities, when and/or as needed, from one or more remote databases 80 via the device.

According to the invention, the device's OS 60 may be canvassed to ensure compliance of the applications 30 with the appropriate operating system 85a-c. Thereafter, according to some preferred embodiments of the invention, the interfacing sub-layer 54 may be provided with the ability to interface with the appropriate device operating system 60.

The platform 50 may selectively access the device OS API 62, the device OS logic 64 and/or the device hardware 20 (e.g., location services using the geographical tracking device 28, camera functionality using the optical sensor 24) directly.

As also shown in FIG. 3, the remote databases 80 may be accessed by the device over one or more wired or wireless communication networks 200. The remote databases 80 are shown to include a cursor position database 81, an application database 82, a platform OS version database 85, and a sensed data database 84 (alternately spaced data database 84), as well as databases of other information 83. According to the invention, the platform 50, the device with its underlying operating system 60, and/or various applications 30 may be served by one or more of these remote databases 80.

According to the invention, the remote databases 80 may take the form of one or more distributed, congruent and/or peer-to-peer databases which may preferably be accessible by the device 20 over the communication network 200, including terrestrial and/or satellite networks—e.g., the Internet and cloud-based networks.

As shown in FIG. 3, the API sub-layer 52 communicates and/or exchanges data with the various applications (A1, A2, A3) 31, 32, 33.

Persons having ordinary skill in the art should appreciate from FIG. 3 that different platform OS versions 85a-c may be served from the remote databases 80, preferably depending at least in part upon the device OS 60 and/or upon the OS for which one or more of the various applications (A1, A2, A3) 31, 32, 33 may have been written. The different platform OS versions 85a-c may affect the working of the platform's API sub-layer 52 and/or its interfacing sub-layer 54, among other things. According to some embodiments of the invention, the API sub-layer 52 of the platform 50 may interface with applications 30 coded for use in conjunction with a first operating system (OS1) 85a, while the platform's interfacing sub-layer 54 may interface with a second one (OS2) 85b. Still further, some versions of the platform 50 may include an interfacing sub-layer 54 that is adapted for use with more than one device OS 60. The different platform OS versions 85a-c may so affect the working of the API sub-layer 52 and interfacing sub-layer 54 when and/or as needed. Applications 30 which might otherwise be inoperable with a particular device OS 60 may be rendered operable therewith.

The interfacing sub-layer 54 communicates and/or exchanges data with the device and its operating system 60. In some cases, and as shown in FIG. 3, the interfacing sub-layer 54 communicates and/or exchanges data, directly and/or indirectly, with the API 62 or logic 64 of the OS and/or with the device hardware 70. As shown in FIG. 3, the API 62 and/or logic 64 of the OS (and/or the whole OS 60) may pass through such communication and/or data as between the device hardware 70 and the interfacing sub-layer 54. Alternately, and as also shown in FIG. 3, the interfacing sub-layer 54 may, directly, communicate and/or exchange data with the device hardware 70, when possible and required and/or desired. For example, in some embodiments, the platform 50 may access particular components of the device hardware 70 (e.g., the device accelerometer or gyroscope) to provide for configuration and/or operation of those device hardware 70 components.

When appropriate, the spatial data 170 may be stored in and accessible form in the spatial data database 84 of the remote databases 80 (as shown in FIG. 3).

Preferably, the platform 50 includes standard application(s) 30 which utilize the virtual environment 56, and/or can include a software development kit (SDK) which may be used to create other applications utilizing the system 100.

Gestures

In operation, the mobile device processor(s) 167b is preferably configured to process the spatial data 170 to determine real-time coordinates to define a cursor 156 within the virtual environment 56 that corresponds to each gesture controller 150 in three dimensional space (e.g., XYZ coordinate data).

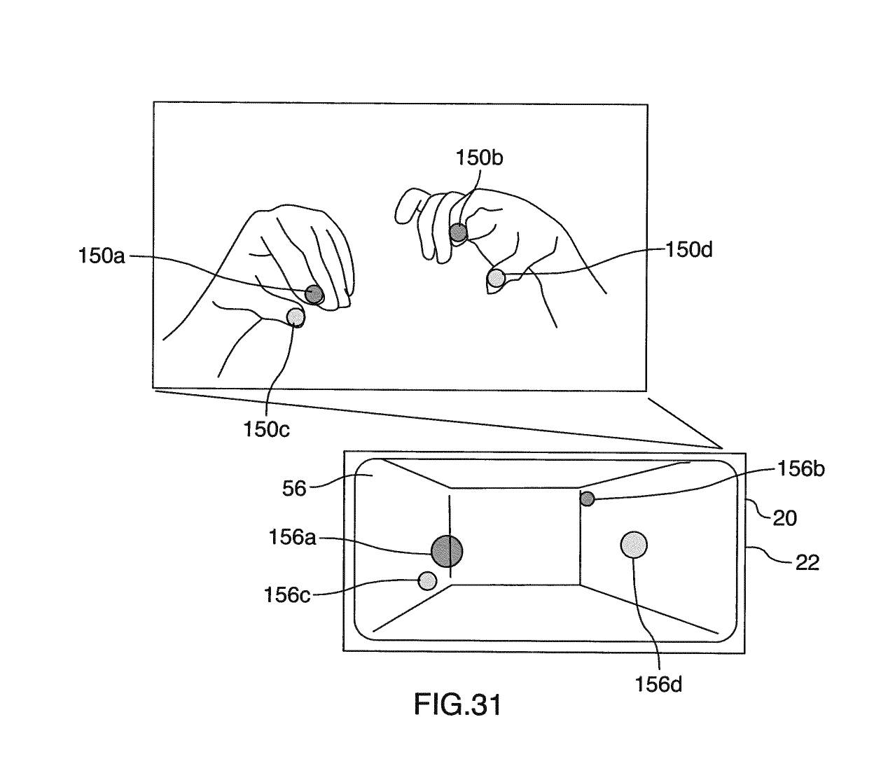

With four or more positional inputs (as shown in FIGS. 30 and 31), the mobile device processor(s) 167b can be configured to detect control gestures including but not limited to:

(a) pinching and zooming with both hands independently;

(b) twisting, grabbing, picking up, and manipulating three dimensional forms much more intuitively (e.g., like ‘clay’);

(c) performing whole hand sign gestures (e.g., a ‘pistol’); and/or

(d) using depth along the z-axis to ‘click’ at a certain depth distance, XY movements of the cursor 156 will hover, but once a certain distance of the cursor 156 along the z-axis is reached, a virtual button can preferably be ‘pressed’ or ‘clicked’.

In some preferable embodiments, the foregoing control gestures can be more natural or intuitive than traditional input means of the prior art. It will be understood that any system or gesture controls can be employed within the present invention.

The mobile device processor(s) 167b may preferably be configured to provide visual feedback of the position of the gesture controllers 150a,b,c,d by displaying cursors 156a,b,c,d (illustrated for example as dots) that hover in the platform GUI 56. In some preferable embodiments, to represent depth along the z-axis, the further an individual gesture controller 150a,b,c,d is positioned from the mobile device 20, the smaller the cursor 156a,b,c,d, and the closer the gesture controller 150a,b,c,d, the larger the cursor 156a,b,c,d. In some examples, the different cursors 156a,b,c,d can be different shapes and/or colours to distinguish between each of the gesture controllers 150a,b,c,d.

In some alternate preferable embodiments with two gesture controllers 150e,f (e.g., one on each index finger of the user 10), a ‘click’ or ‘pinch’ input can be detected when the user 10 pinches his/her thumb to his/her index finger thereby covering or blocking some or all of the light emitted by the lighting element(s) 152. The system 100 can be configured to interpret the corresponding change in the size, shape and/or intensity of the detected light as a ‘click’, ‘pinch’ or other input.

In some preferable embodiments with two gesture controllers 150e,f with lighting elements 152, a ‘home’ or ‘back’ input can be detected when a user 10 makes a clapping motion or any similar motion that brings each index finger of the user 10 into close proximity to each other. The system 100 can be configured to interpret the movement of the two lighting elements 152 together as a ‘home’, ‘back’ or other input. Preferably, the moving together of the light emitting elements 152 must be in a substantially horizontal direction or must have started from a defined distance apart to be interpreted as a ‘home’, ‘back’ or other input. In some examples, this may reduce false positives when the user 10 has his/her hands in close proximity to each other.

Hover Bounding Box or Circle

In some preferable embodiments, the system 100 can be configured to enable a user 10 to virtually define a bounding box within the platform GUI 56 that determines the actual hover ‘zone’ or plane whereby once the cursors 156 move beyond that zone or plane along the z-axis, the gesture is registered by the system 100 as a ‘click’, preferably with vibration tactile feedback sent back to the finger, to indicate a ‘press’ or selection by the user 10.

Thumb and Index Finger Pinch

In another preferable embodiment, two of the gesture controller(s) 150a,b can be clicked together to create an ‘activation state’. For example, when drawing in three dimensions, the index finger can be used as a cursor 156a,b, when clicked with the thumb controller 150c,d, a state activates the cursor to draw, and can be clicked again to stop the drawing.

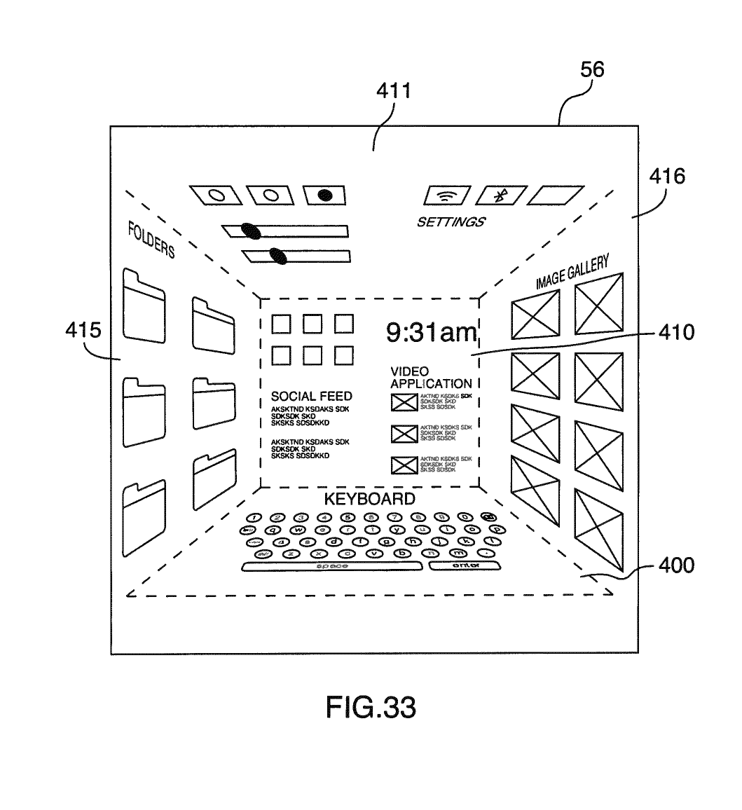

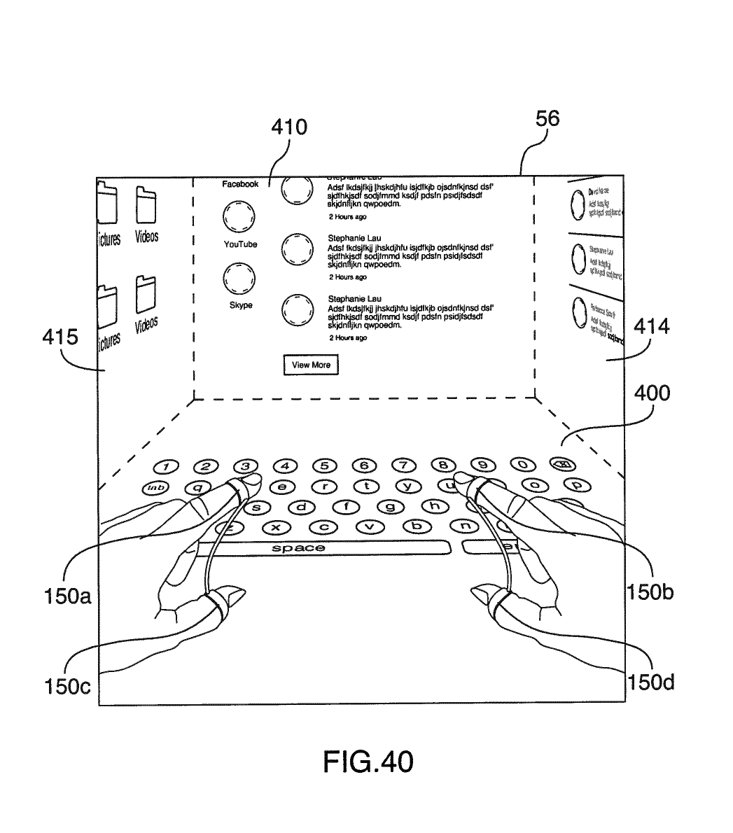

In preferable embodiments, as best shown in FIGS. 33 and 40, a virtual keyboard 400 may be displayed on the platform GUI 56, and ‘pinch’ or ‘click’ inputs can be used to type on the keyboard 400.

In some preferable embodiments, the system 100 can be configured such that pinching and dragging the virtual environment 56 moves or scrolls through the environment 56.

In further preferable embodiments, the system 100 can be configured such that pinching and dragging the virtual environment 56 with two hands resize the environment 56.

Head Gestures

The system 100 can, in some preferable embodiments, be configured to use motion data 29 (preferably comprising data from the optical sensor 24, accelerometer(s) 26, gyroscope(s) 27 and/or geographic tracking device 28) from the mobile device 20 to determine orientation and position of the head of the user 10 using the head tracking algorithm 801a,b. In one example, the motion data 29 can be used to detect head gestures like nodding, or shaking the head to indicate a “YES” (e.g., returning to a home screen, providing positive feedback to an application, etc.) or “NO” (e.g., closing an application, providing negative feedback to an application, etc.) input for onscreen prompts. This may be used in conjunction with the gesture controllers 150a,b,c,d to improve intuitiveness of the experience.

Panels

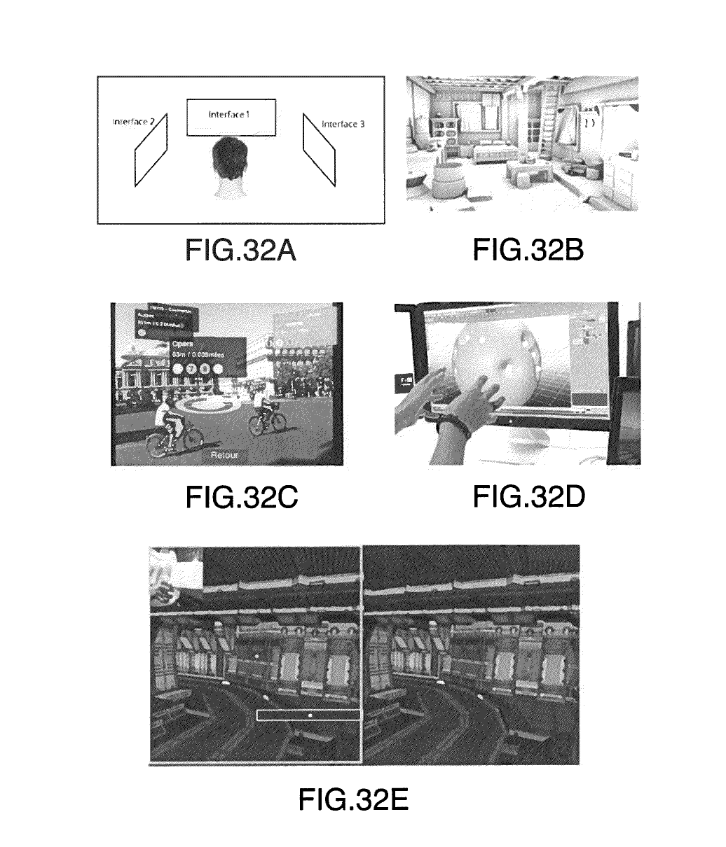

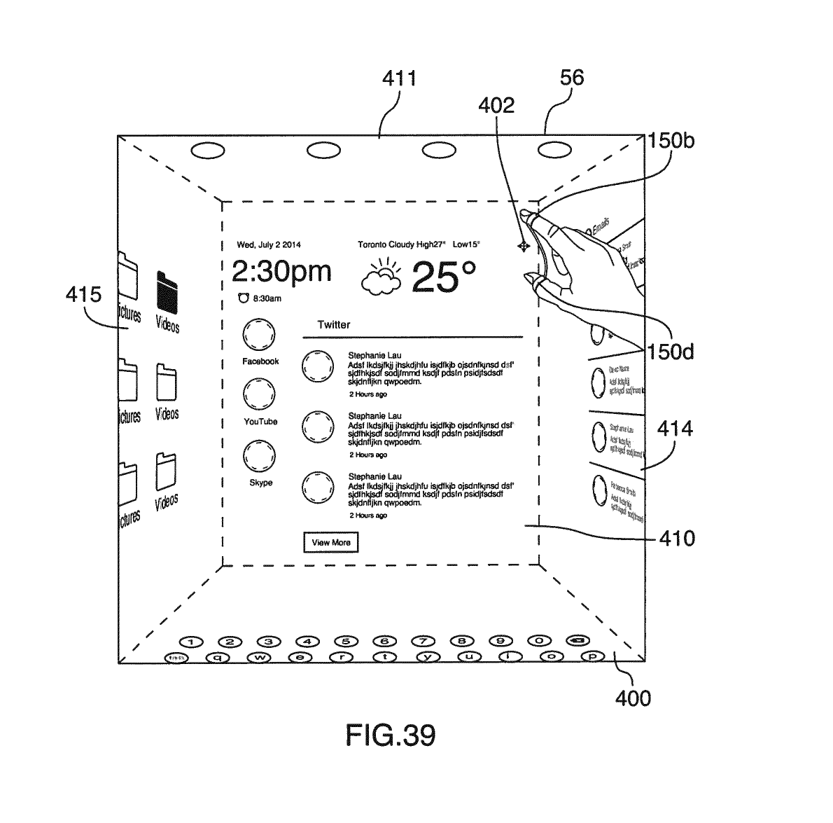

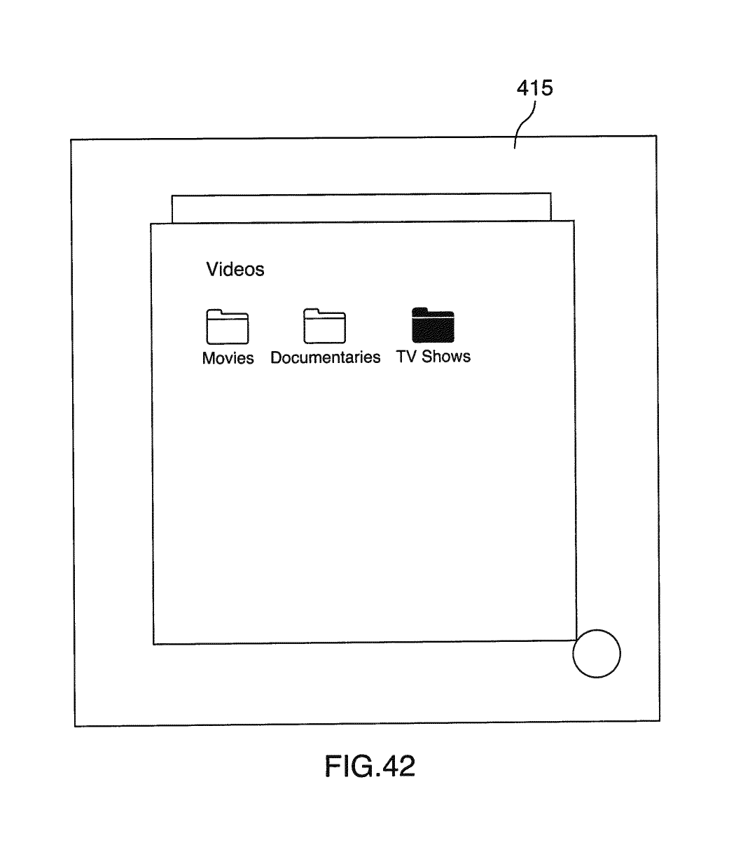

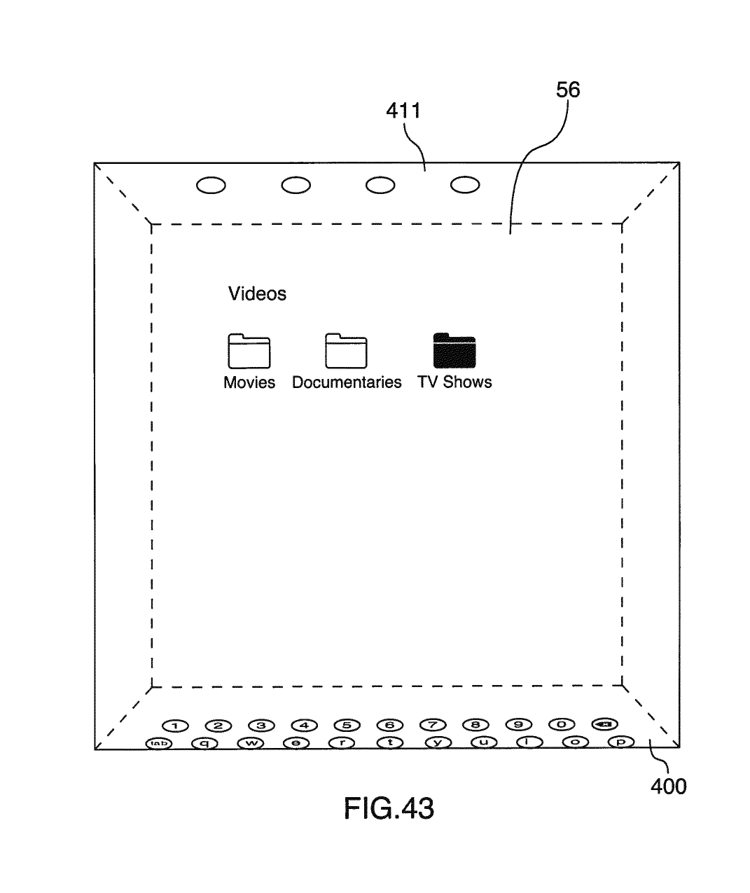

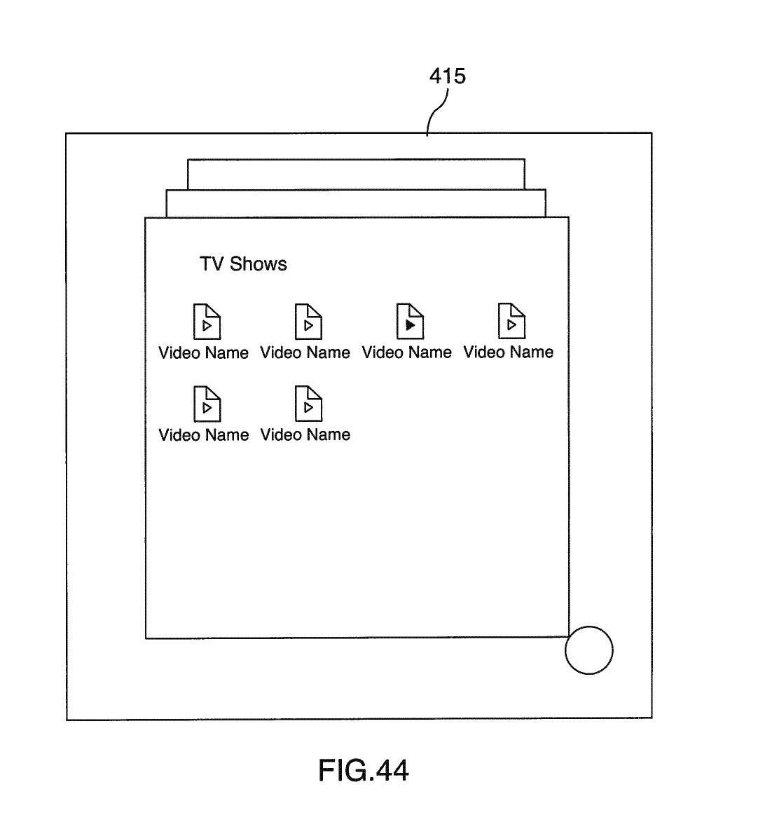

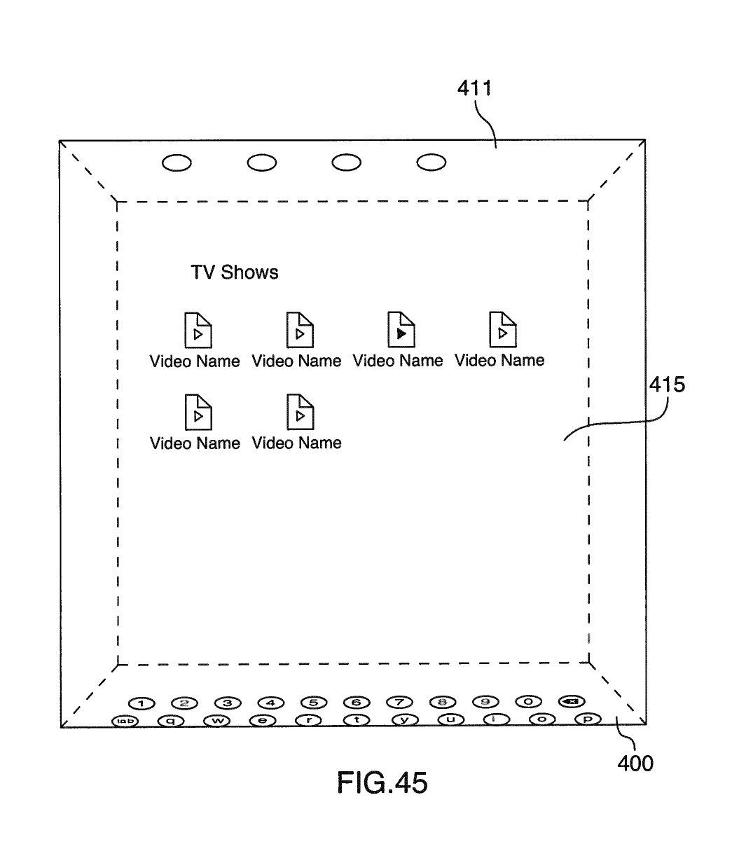

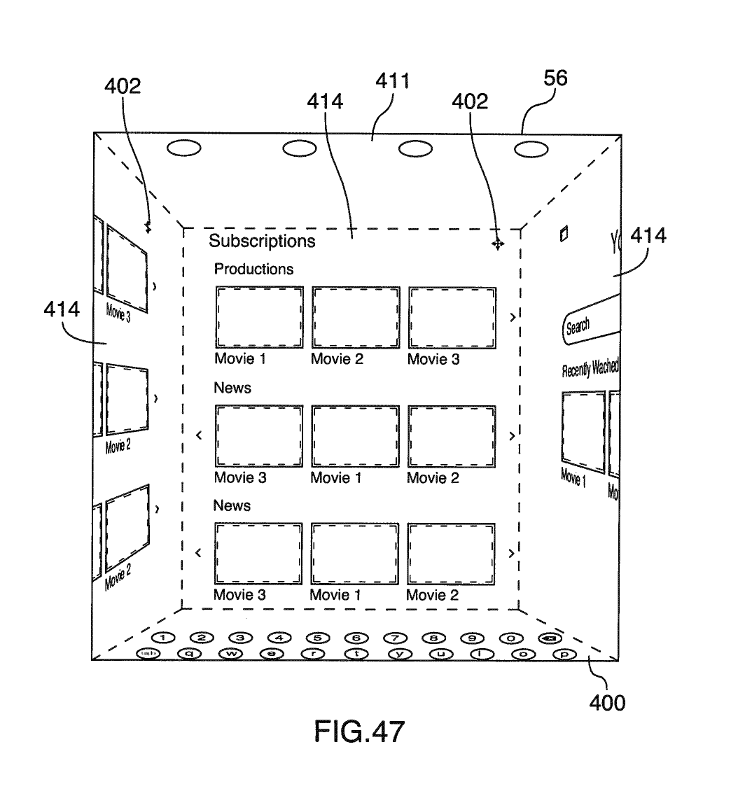

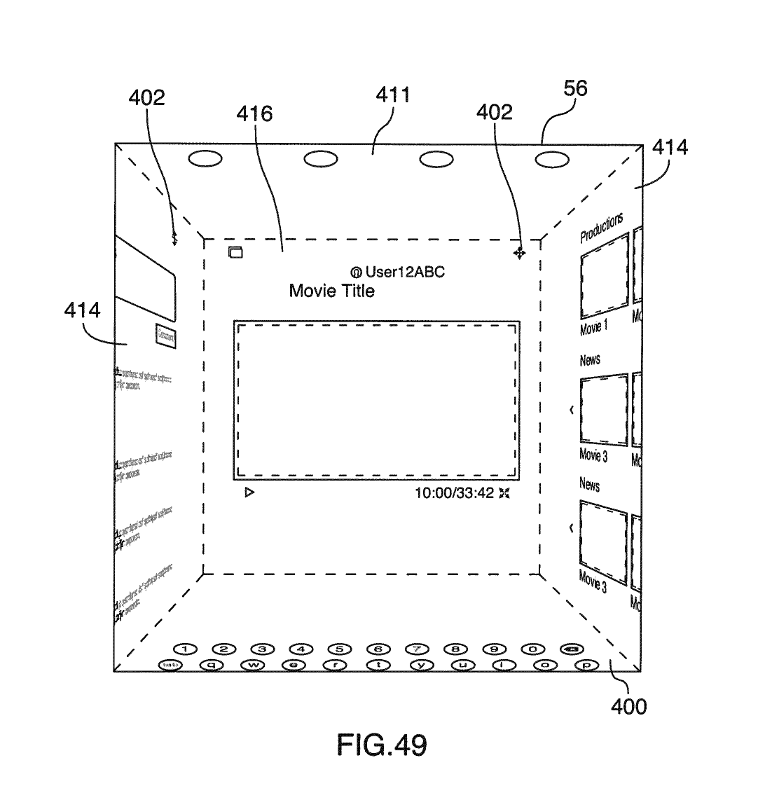

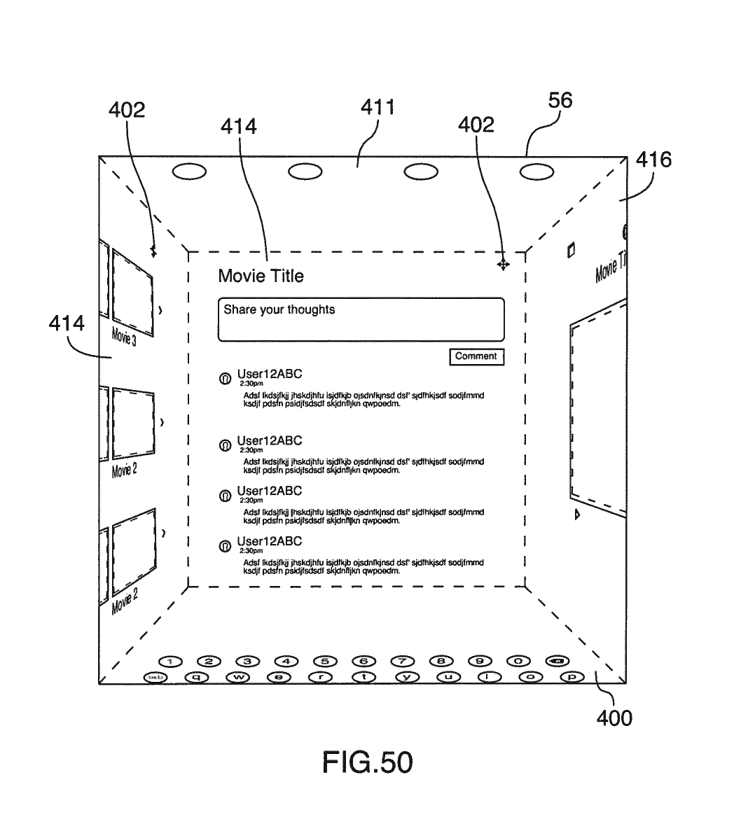

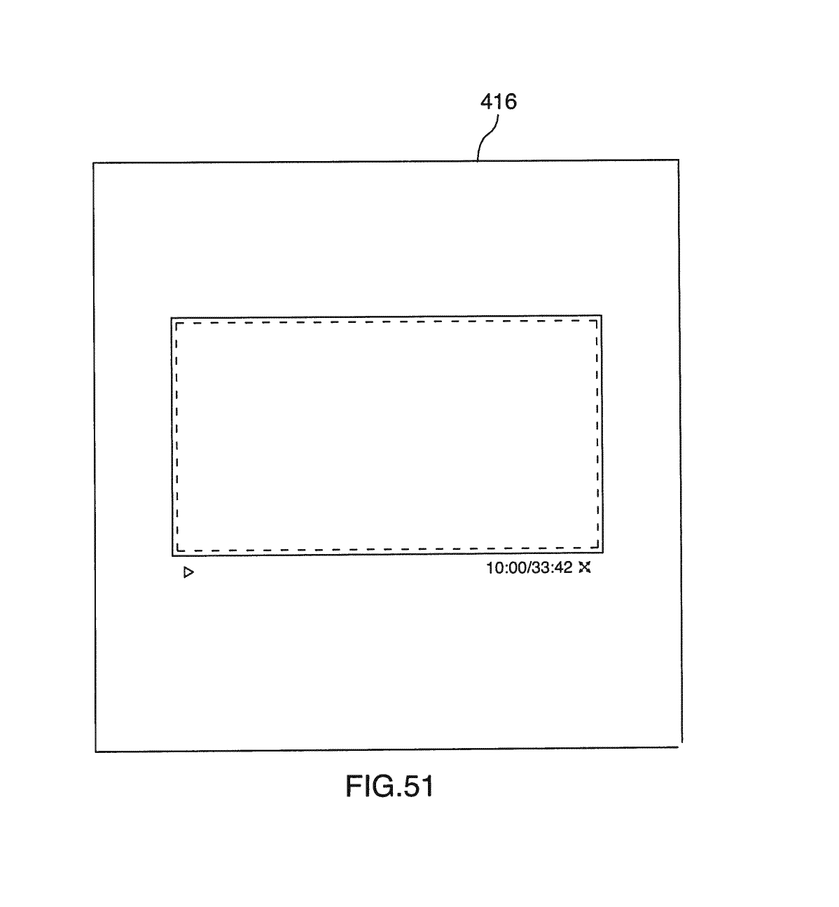

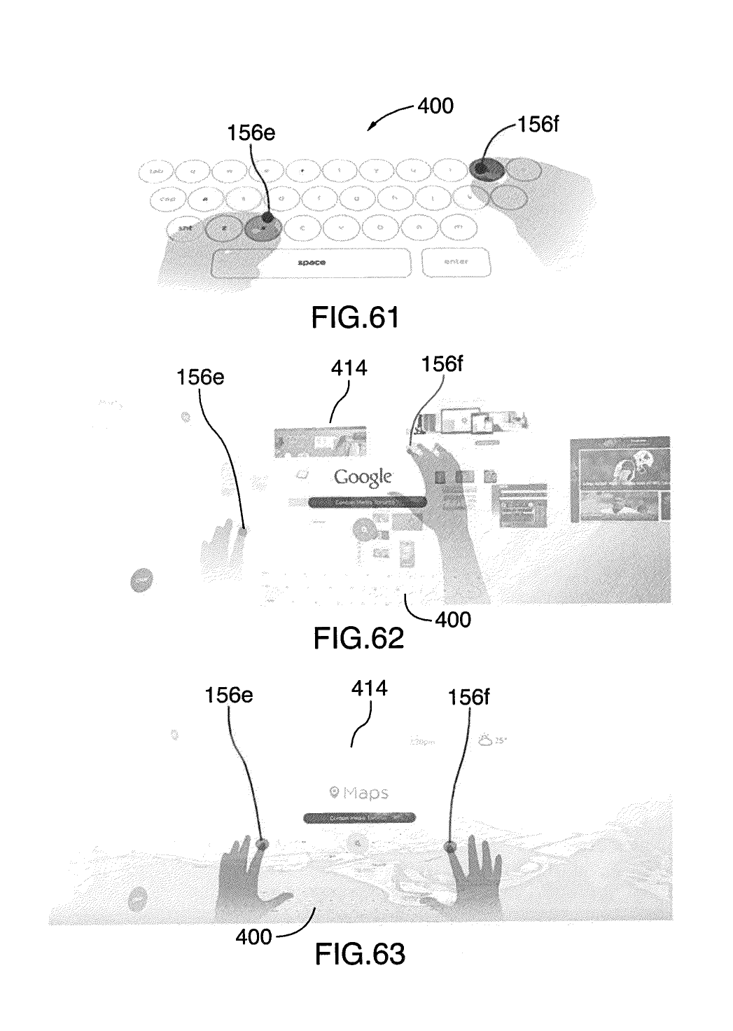

FIGS. 32-51 and 61-66 are graphical representations of an interface which may preferably be presented by the GUI 22. As best shown in FIGS. 33, 37-41, 45-47, 49, 50 and 61-66, the device GUI 22 preferably presents, among other things, components for allowing the user 10 to interact with the three dimensional virtual environment 56 and/or objects in the virtual environment 56 including, a dashboard or home screen 410, a settings screen 411, an applications screen 414 (including third party applications), a search and file management screen 415 and/or a media screen 416. Objects may preferably include virtual buttons, sliding bars, and other interactive features which may be known to purposes skilled in the art.

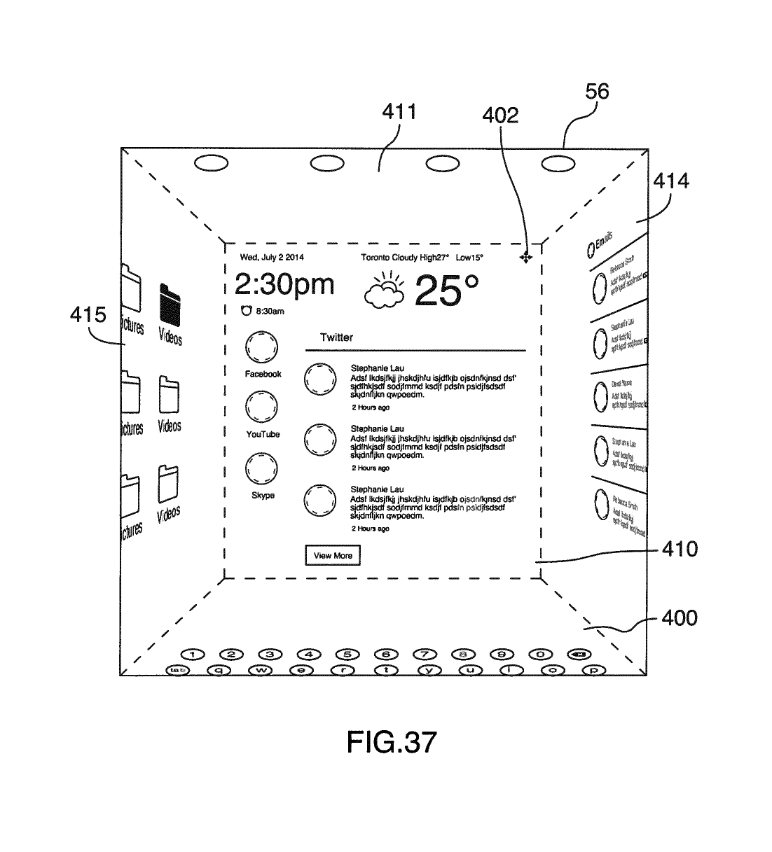

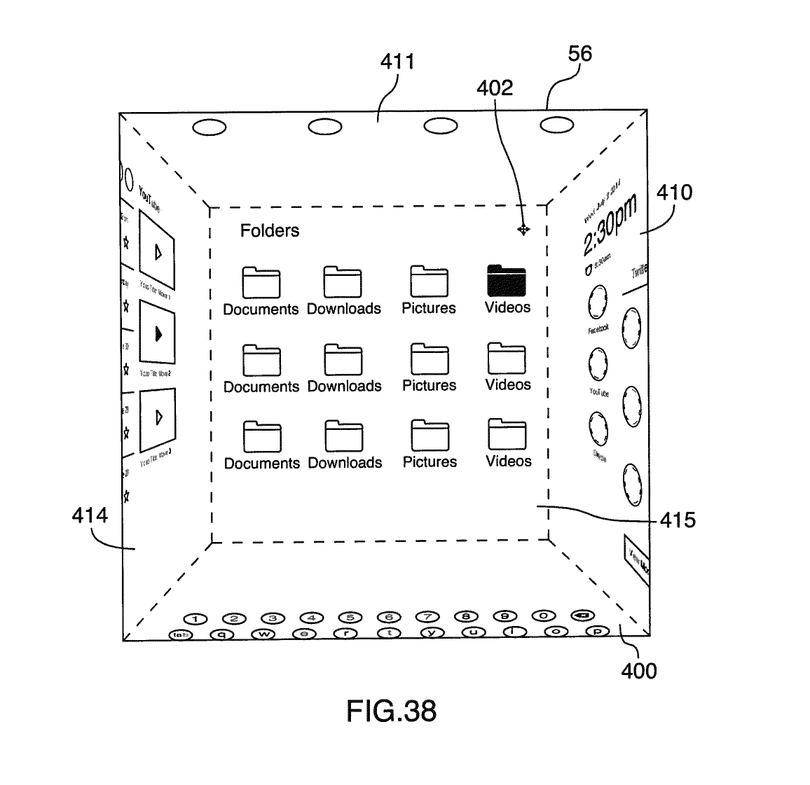

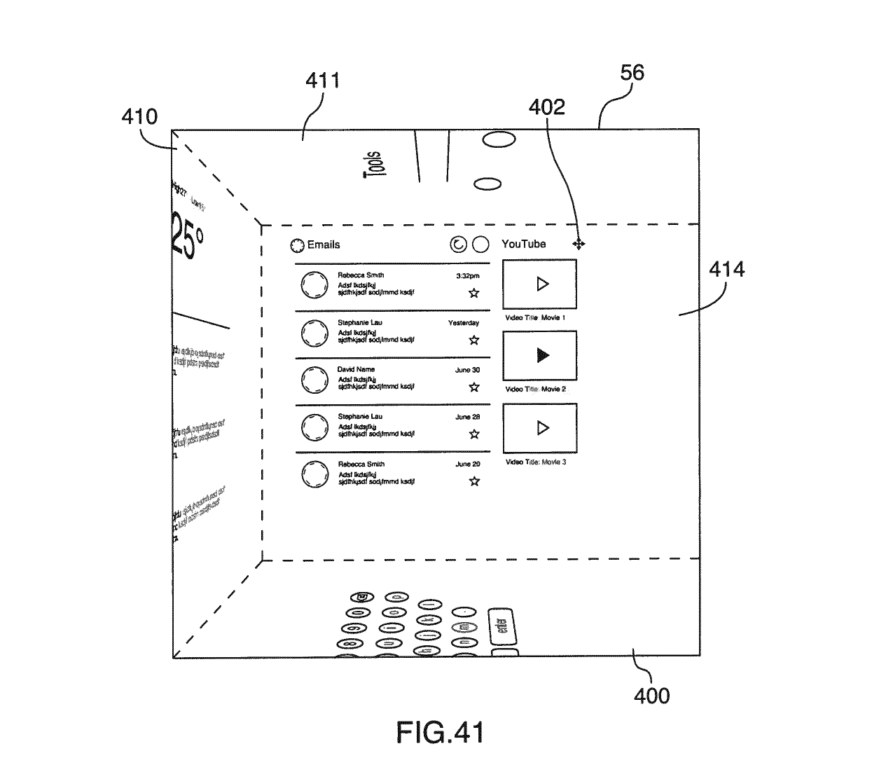

In preferable embodiments, with a three dimensional virtual environment 56, the platform 50 can be navigated in more than two dimensions and can provide a user 10 with the ability to orient various applications 30 of the platform 50 within the multiple dimensions. Preferably, in some embodiments, with reference for example to FIGS. 33, 37-41, 43, 45-47, 49, 50 and 66, the platform 50 can be visualized as a cube (or other three dimensional object) with the user 10 in the centre of that cube or object. The user 10 may be running a map application within the field of view, while the keyboard 400 and sliders are at the bottom, a chat/messaging application can be on the left panel (alternately screen) (FIG. 63), while other applications can be positioned at other points within the virtual environment (e.g., local weather above the map). To access the various screens 410,411,414,415,416 of the platform 50, the user 10 preferably rotates his or her head to look around the environment 56. This can allow multiple applications 30 to run in various dimensions with interactivity depending on the physical orientation of the user 10. In other preferable embodiments, the user 10 may access the various screens 410,411,414,415,416 by selecting them with one or more cursors or by using an anchor 402 (described below). For example, in FIG. 37, the virtual environment 56 is oriented such that the home screen 410 is directly in front of the field of view of the user 10 with a search and file management screen 415 to the left of the field of view of the user 10. In this configuration, the user 10 may access the search and file management screen 415 by turning his/her head to the left or using one or more cursors to rotate the environment 56 (e.g., using the anchor 402) to the left so that the search and file management screen 415 is directly in front of the field of view of the user 10 and the home screen 410 is to the right of the field of view of the user 10 (as shown in FIG. 38). In another example, as shown in FIG. 41, a user 10 may rotate the environment 56 (e.g., by turning his/her head or by using one or more cursors) to view the email application screen 414 shown in FIG. 37.

Each screen 410,411,414,415,416 can preferably house one or more applications 30 (e.g., widgets or a component like keyboard 400 or settings buttons 401). In some examples, the platform 50 may be envisioned as an airplane cockpit with interfaces and controls in all dimensions around the user 10.

In some preferable embodiments, the platform 50 includes preloaded applications 30 or an applications store (i.e., an ‘app’ store) where users 10 can download and interact with applications 30 written by third party developers (as shown in FIG. 3).

Orientation and Anchoring

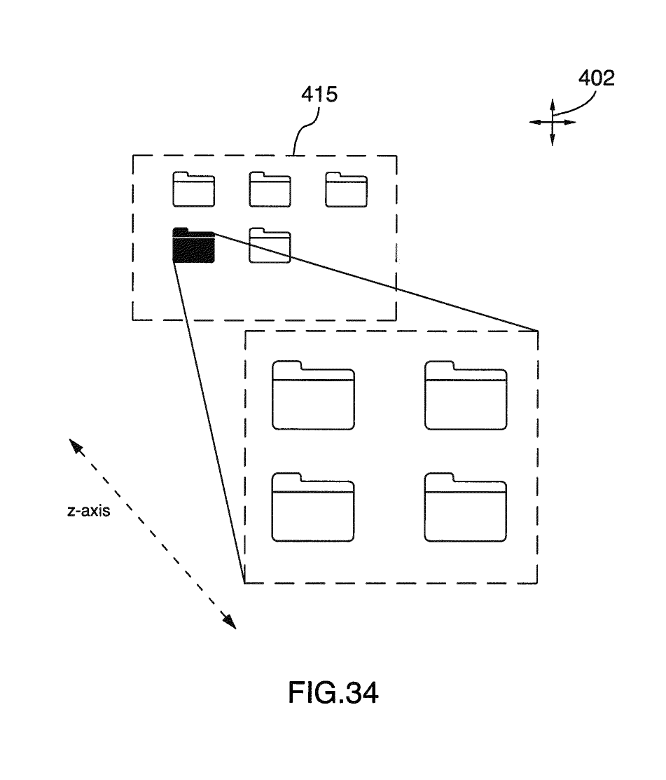

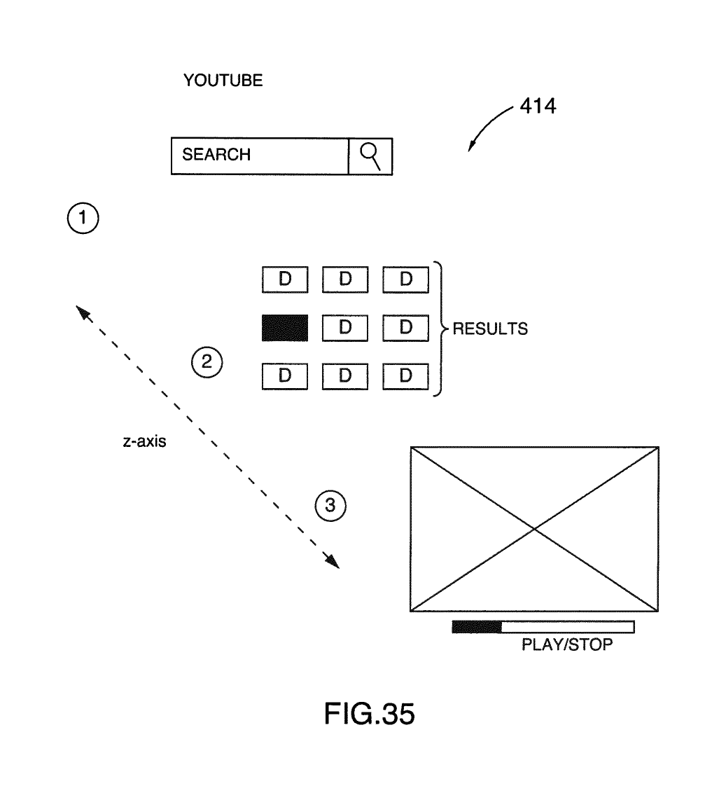

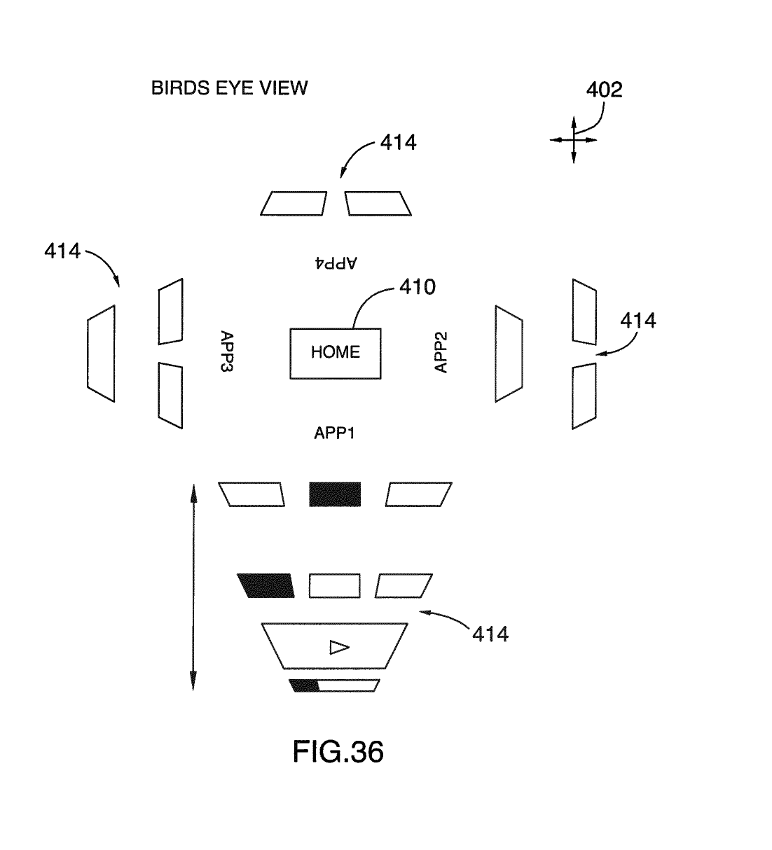

The virtual environment 56 can, in some preferable embodiments, be configured for navigation along the z-axis (i.e., depth). Most traditional applications in the prior art have a back and/or a home button for navigating the various screens of an application. The platform 50 preferably operates in spatial virtual reality, meaning that the home page or starting point of the platform 50 is a central point that expands outwardly depending on the amount of steps taken within a user flow or navigation. For example, a user 10 can start at a home dashboard (FIG. 33), and open an application such as the search and file management screen 415, the file management screen 415 can be configured to open further out from the starting point and move the perspective of the user 10 away from the dashboard (FIG. 34)—resulting in a shift in the depth along the z-axis. If the user 10 desires to go back to his/her original starting point, the user 10 can grab the environment 56 (e.g., by using gestures, one or more cursors 156 and/or the anchor 402) and move back towards the initial starting point of the home screen 410. Conversely, if the user 10 desires to explore an application 414 further (for example a third party media application), and go deep within its user flow, the user 10 would keep going further and further away from his/her starting point (e.g., the home screen 410) along the z-axis depth (FIG. 35). The user 10 also preferably has an anchor 402 located at the top right of their environment 56 (FIGS. 34 and 36), which allows the user 10 to drag forwards and backwards along the z-axis—it also can allow for a ‘birds eye view’ (as shown in FIG. 36) that shows all of the applications and their z-axis progression at a glance from a plan view. In some preferable embodiments, the platform 50 may be constructed within the virtual environment 56 as a building with rooms, each room contains its own application—the more applications running, and the further the user 10 is within the application screens, the more rooms get added to the building. The anchor 402 preferably allows the user to go from room to room, even back to their starting point—the anchor can also allow the user to see all running applications and their sessions from a higher perspective (again the bird's eye view, as shown in FIG. 36) much like seeing an entire building layout on a floor plan.

Head Tracking and Peeking

In some preferable embodiments, the relative head position of the user 10 is tracked in three dimensions, using the motion data 29 and head tracking algorithm 801a,b, allowing users 10 to view the virtual environment 56 by rotating and/or pivoting their head. In addition, head location of the user 10 may be tracked by the geographic tracking device 28 if the user physically moves (e.g., step backwards, step forwards, and move around corners to reveal information hidden in front or behind other objects). This allows a user 10 to, for example, ‘peek’ into information obstructed by spatial hierarchy within the virtual environment 56 (for example, FIG. 41).

Folders, Icons and Objects

As depicted in FIGS. 34 and 42-45, folders and structures within structures in the Platform 50 work within the same principles of z-axis depth and can allow users 10 to pick content groupings (or folders) and go into them to view their contents. Dragging and dropping can be achieved by picking up an object, icon, or folder with both fingers, using gestures and/or one or more cursors 156 within the environment 56—for example, like one would pick up an object from a desk with one's index finger and thumb. Once picked up, the user 10 can re-orient the object, move it around, and place it within different groups within the file management screen 415. For example, if a user 10 desired to move a file from one folder to another, the user 10 would pick up the file with one hand (i.e., the cursors 156 within the virtual environment 56), and use the other hand (i.e., another one or more cursors 156 within the virtual environment 56) to grab the anchor 402 and rotate the environment 56 (i.e., so that the file may preferably be placed in another folder on the same or different panel) and then let go of the object (i.e., release the virtual object with the one or more cursors 156) to complete the file movement procedure.

Spatial Applications for the OS

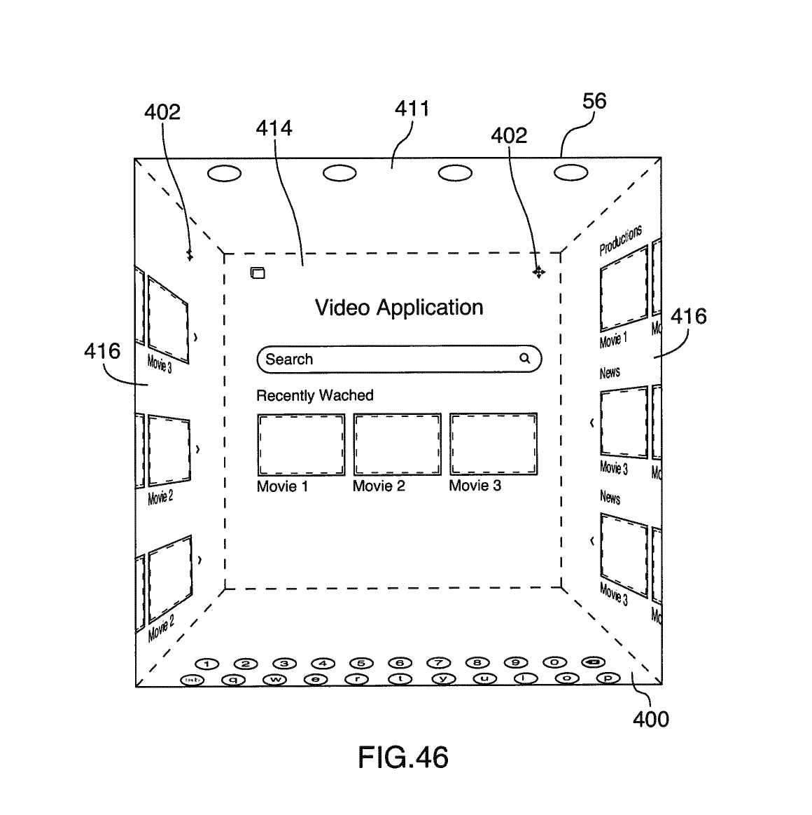

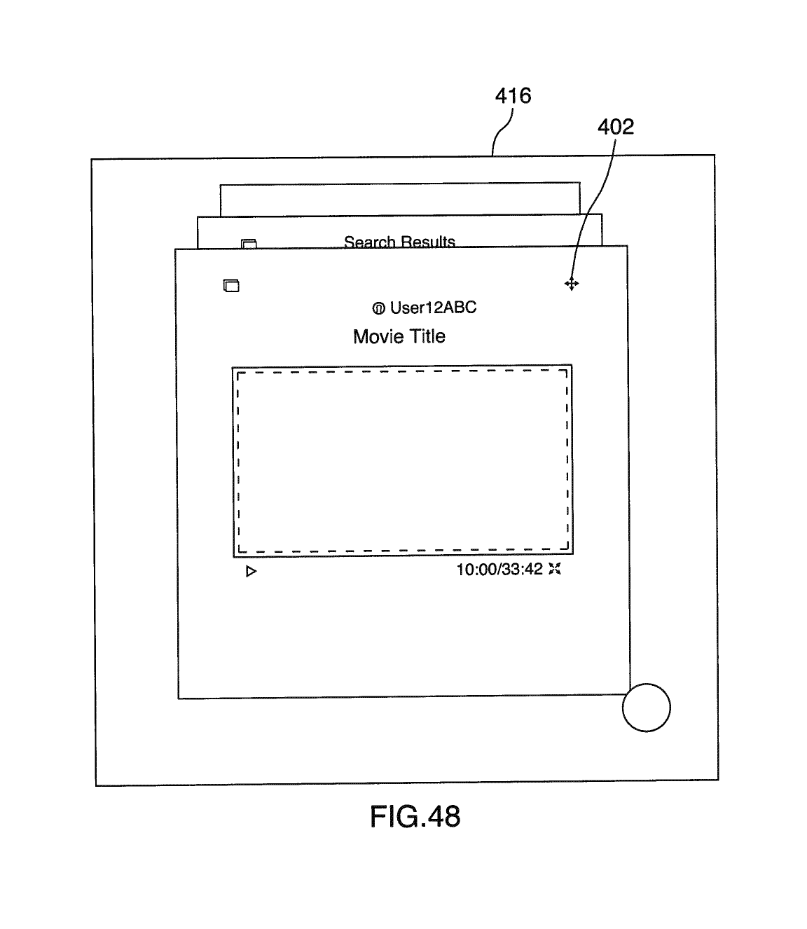

Every application 30 can potentially have modules, functions and multiple screens (or panels). By assigning various individual screens to different spatial orientation within the virtual environment 56, users 10 can much more effectively move about an application user flow in three dimensions. For example, in a video application, a user 10 may preferably first be prompted by a search screen (e.g., FIGS. 35 and 46), once a search is initiated, the screen preferably recedes into the distance while the search results come up in front of the user 10. Once a video is selected, the search results preferably recedes to the distance again resulting in the video being displayed on the platform GUI 56 (e.g., FIG. 48). To navigate the application, the user 10 can go forward and back along the z-axis (e.g., using gestures, one or more cursors 156 and/or the anchor 402), or move up and down along the x and y axes to sort through various options at that particular section.

As shown in FIGS. 46-51, a user 10 can navigate between, for example, the search screen, a subscription screen, a comment page, a video playing page, etc. by turning his/her head, or otherwise navigating the three dimensional environment (e.g., using gestures, one or more cursors 156 and/or the anchor 402).

Cursor Tracking Process

The cursor tracking process 300, using the cursor tracking algorithm 802a,b, includes obtaining, thresholding and refining an input image 180 (i.e., from the visual data), preferably from the optical sensor 24, for tracking the lighting elements 152. Preferably, the tracking process 300 uses a computer vision framework (e.g., OpenCV), a computer vision framework. While the exemplary code provided herein is in the C++ language, skilled readers will understand that alternate coding languages may be used to achieve the present invention. Persons skilled in the art may appreciate that the structure, syntax and functions may vary between different wrappers and ports of the computer vision framework.

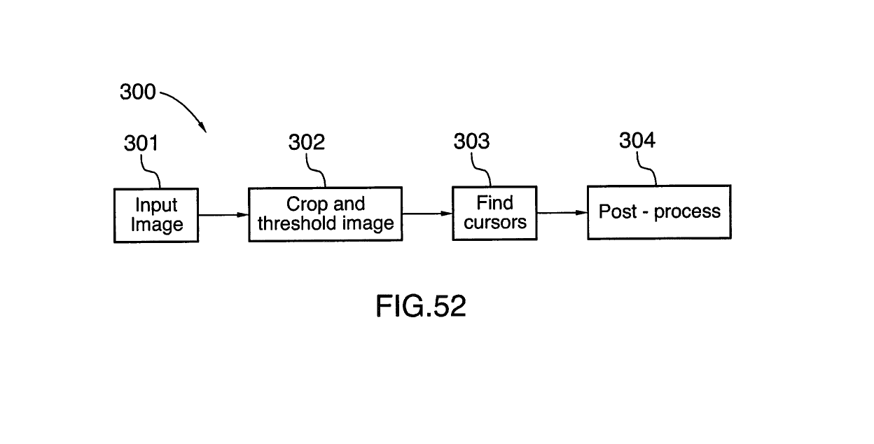

As depicted in FIG. 52, the process 300 preferably comprises an input image step 301 comprising a plurality of pixels, a crop and threshold image step 302, a find cursors step 303, and a post-process step 304. In preferable embodiments, the process 300 decreases the number of pixels processed and the amount of searching required (by the processors 167) without decreasing tracking accuracy of the lighting elements 152.

(a) The Input Image Step

For the input image step 301, each input image 180 received by the optical sensor 24 of the mobile device 20 is analyzed (by the processor(s) 167). Preferably, the input image 180 is received from the optical sensor 24 equipped with a wide field of view (e.g., a fish-eye lens 111) to facilitate tracking of the lighting elements 152 and for the comfort of the user 10. In preferable embodiments, the input image 180 received is not corrected for any distortion that may occur due to the wide field of view. Instead, any distortion is preferably accounted for by transforming the cursor 156 (preferably corresponding to the lighting elements 152) on the inputted image 180 using coordinate output processing of the post-process step 304.

(b) The Crop and Threshold Image Step

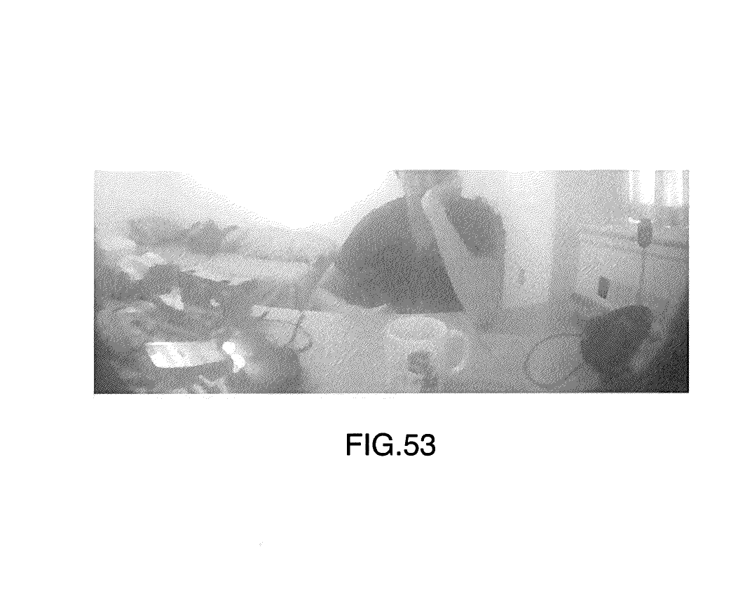

In preferable embodiments, as depicted in FIG. 53, a crop and threshold image step 302 is applied to the input image 180 since: (a) an input image 180 that is not cropped and/or resized may become increasingly computationally intensive for the processor(s) 167 as the number of pixels comprising the input image 180 increases; and (b) the comfort of the user 10 may become increasingly difficult as the user 10 begins to raise his/her arms higher (i.e., in preferable embodiments, the user 10 is not required to raise his/her arms too high to interact with the virtual environment—that is, arm movements preferably range from in front of the torso of the user to below the neck of the user). To increase the comfort of the user 10, the top half of the input image 180 is preferably removed using the cropping algorithm 803a,b. Further cropping is preferably applied to the input image 180 to increase performance of the system 100 in accordance with the search area optimization process of the post-process step 304.

Preferably, the computer vision framework functions used for the crop and threshold image step 302 include:

(a) “bool bSuccess=cap.read(sizePlaceHolder)”, which preferably retrieves the input image 180 from the optical sensor 24;

(b) “resize(sizePlaceHolder, imgOriginal, Size(320, 120))”; and

(c) “imgOriginal=imgOriginal(bottomHalf)”, which preferably crops the input image 180.

Preferably, the cropped image 181a has a pixel density of 320×120 pixels in width and height, respectively. Persons skilled in the art may appreciate that the foregoing resolution may not be a standard or default resolution supported by optical sensors 24 of the prior art. Accordingly, an input image 180 must preferably be cropped and/or resized before further image processing can continue. An input image 180 (i.e., an unprocessed or raw image) is typically in a 4:3 aspect ratio. For example, optical sensors 24 of the prior art typically support a 640×480 resolution and such an input image 180 would be resized to 320×240 pixels to maintain the aspect ratio. The crop and threshold image step 302 of the present invention reduces or crops the height of the input image 180, using the cropping algorithm 803a,b, to preferably obtain the aforementioned pixel height of 120 pixels.

Colour Threshold

The crop and threshold image step 302 also preferably comprises image segmentation using the thresholding algorithm 804a,b. Colour thresholds are preferably performed on an input image 180 using a hue saturation value (“HSV”) colour model—a cylindrical-coordinate representation of points in an RGB colour model of the prior art. HSV data 172 preferably allows a range of colours (e.g., red, which may range from nearly purple to nearly orange in the HSV colour model) to be taken into account by thresholding (i.e., segmenting the input image 180) for hue—that is, the degree to which a stimulus can be descried as similar to or different from stimuli that are described as red, green, blue and yellow. After the image 180 has been thresholded for hue, the image 180 is preferably thresholded for saturation and value to determine the lightness and or colorfulness (e.g., the degree of redness and brightness) of a red pixel (as an example). Therefore, the image 180, which is inputted as a matrix of pixels, each pixel having a red, blue, and green value, is converted into a thresholded image 181b preferably using an computer vision framework function.

HSV thresholding ranges are preferably determined for different hues, for example red and green, for tracking the lighting elements 152. In preferable embodiments, red and green are used for tracking the lighting elements 152 as they are primary colours with hue values that are further apart (e.g., in an RGB colour model) than, for example, red and purple. While persons skilled in the art may consider the colour blue as not optimal for tracking because the optical sensor 24 may alter the “warmth” of the image depending on the lighting conditions by decreasing or increasing HSV value for the colour blue; skilled readers may appreciate that the lighting elements 152 may emit colours other than red and green for the present invention.

In preferable embodiments, HSV ranges for the thresholded image 181b use the highest possible “S” and “V” values because bright lighting elements 152 are preferably used in the system 100. Persons skilled in the art, however, will understand that HSV ranges and/or values may vary depending on the brightness of the light in a given environment. For example, the default red thresholding values (or HSV ranges) for an image 181b may include:

“int rLowH=130”;

“int rHighH=180”;

“int rLowS=120”;

“int rHighS=255”;

“int rLowV=130”;

“int rHighV=255”; and

“trackbarSetup(“Red”, &rLowH, &rHighH, &rLowS, &rHighS, &rLowV, &rHighV)”.

And, for example, default green thresholding values (or HSV ranges) for an image 181b may include:

“int gLowH=40”;

“int gHighH=85”;

“int gLowS=80”;

“gHighS=255”;

“gLowV=130”;

“gHighV=255”; and

“trackbarSetup(“Green”, &gLowH, &gHighH, &gLowS, &gHighS, &gLowV, &gHighV)”.

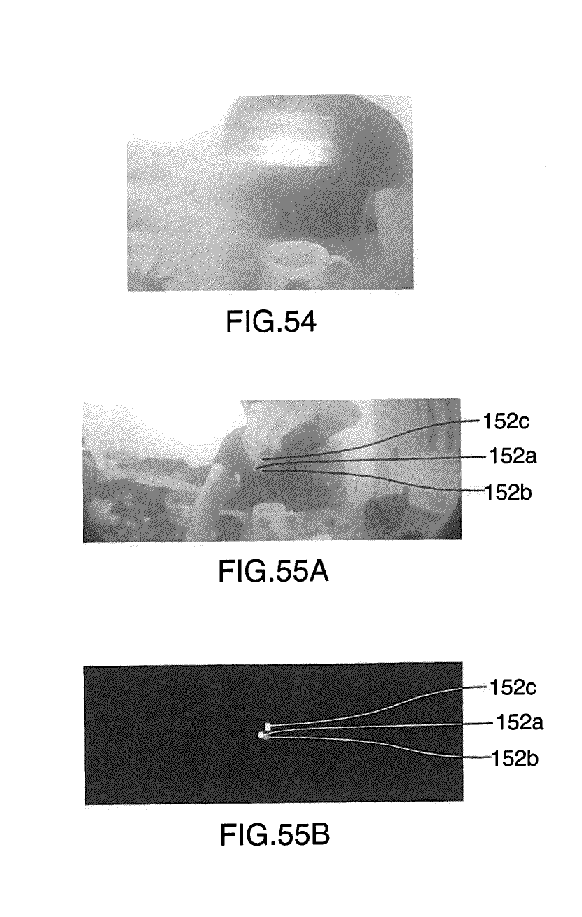

The “S” and “V” low end values are preferably the lowest possible values at which movement of the lighting elements 152 can still be tracked with motion blur, as depicted for example in FIG. 54, which may distort and darken the colours.

Red and green are preferably thresholded separately and outputted into binary (e.g., values of either 0 or 255) matrices, for example, named “rImgThresholded” and “gImgThresholded”.

The computer vision framework Functions used for colour thresholding, preferably include:

(a) “cvtColor(imgOriginal, imgHSV, COLOR_BGR2HSV)”;

(b) “Scalar rLowTresh(rLowH, rLowS, rLowV)”, which is an example threshold value; and

(c) “inRange(*original, *lowThresh, *highThresh, *thresholded)”.

FIGS. 55A and B depict an input image 180 that has been converted to a thresholded image 181b, respectively. Preferably, the relative size, position and colour of the lighting elements 152a,b,c (collectively, lighting elements 152) in the input image 180 correspond with the relative size, position and colour of the lighting elements 152a,b,c in the thresholded image 181b.

Threshold Refinements

Persons skilled in the art may appreciate that the crop and threshold image step 302 may leave behind noise (e.g., a random variation of brightness or color information) in the thresholded image 181b such that objects appearing in the image 181b may not be well defined. Accordingly, the erosion substep 310 and the dilation substep 311 may preferably be applied to thresholded images 181b to improve the definition of the objects and/or reduce noise in the thresholded image 181b.

Application of the erosion substep 310 (i.e., decreasing the area of the object(s) in the thresholded image 181b, including the cursor(s) 156), using the erosion algorithm 805a,b, to the outer edges of the thresholded object(s) in the thresholded image 181b removes background noise (i.e., coloured dots too small to be considered cursors) without fully eroding, for example, cursor dots of more significant size.

Application of the dilation substep 311 (i.e., increasing the area of the object(s) in the thresholded image 181b, including the cursor(s) 156), using the dilation algorithm 806a,b, to the outer edges of the thresholded object(s) in the thresholded image 181b, after the erosion substep 310, preferably increases the definition of the tracked object(s), especially if the erosion substep 310 has resulted in undesirable holes in the tracked object(s).

The erosion substep 310 and dilation substep 311 preferably define boundaries (e.g., a rectangle) around the outer edge of thresholded object(s) (i.e., thresholded “islands” of a continuous colour) to either subtract or add area to the thresholded object(s). The size of the rectangle determines the amount of erosion or dilation. Alternatively, the amount of erosion or dilation can be determined by how many times the erosion substep 310 and/or the dilation substep 311 is performed. However, altering the size of the rectangles rather than making multiple function calls has a speed advantage for the substeps 310, 311. In other preferable embodiments, ellipses are provided as a computer vision framework choice, but rectangles are computationally quicker.

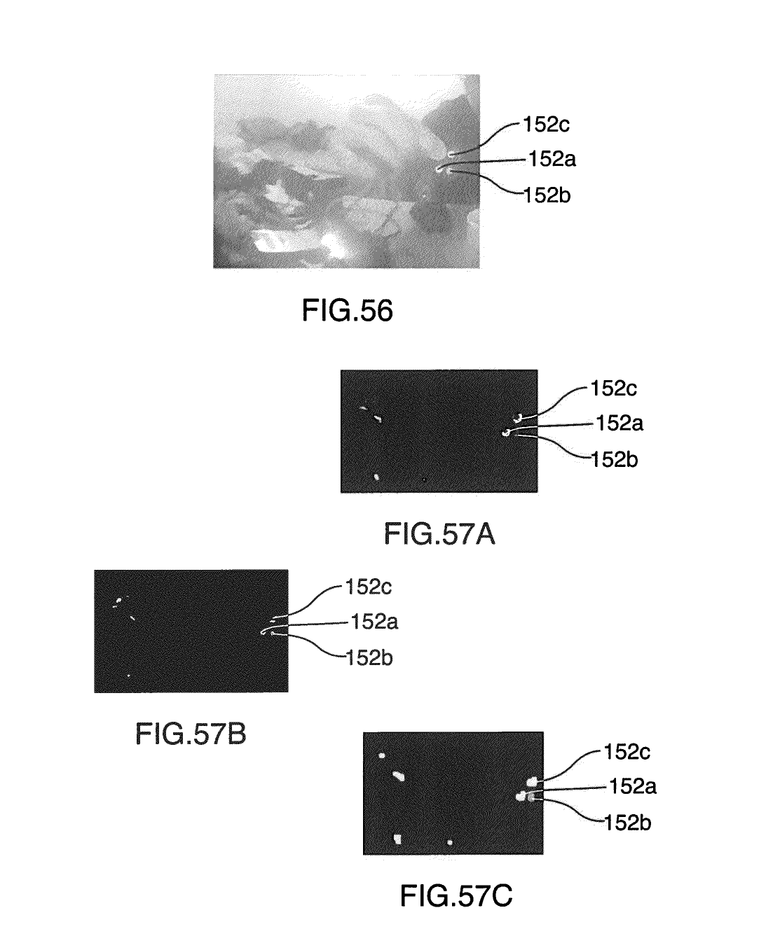

FIGS. 56 and 57 illustrate the effect of the erosion substep 310 and the dilation substep 311. FIG. 56 depicts a thresholded image 181b. FIGS. 57 A-C depict a thresholded image 181b before the erosion substep 310, the thresholded image 181b after the erosion substep 310, and the thresholded image 181b after the dilation substep 311 respectively. FIG. 57 shows a large amount of green background noise on the left side of the image and the lighting element 152a,b,c is on the right side of the image. In FIG. 57, more applications of the dilation substep 311 (i.e., 8×8 pixel rectangles) are performed than the erosion substep 310 (i.e., 2×2 pixel rectangles).

A processed image 182 preferably comprises a combination of the corresponding cropped image 181a and the corresponding thresholded image 181b.

Find Cursors Step

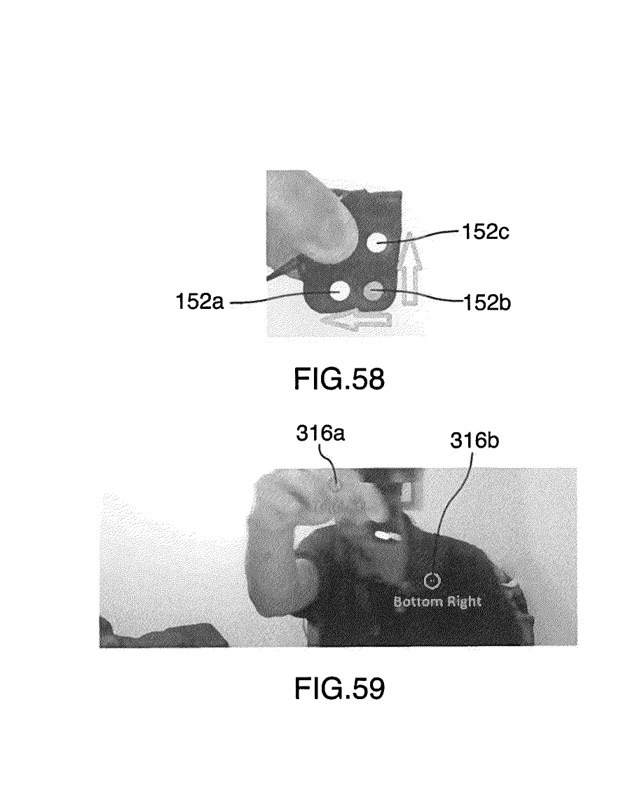

For the find cursors step 303, as shown in FIG. 58, an “L” shaped pattern is preferably defined by the lighting elements 152a,b,c to facilitate position tracking of the cursor 156, using the cursor tracking algorithm 802a,b, and click state. In an alternative embodiment, the lighting elements 152a,b,c may be positioned in a linear pattern (not shown). Persons skilled in the art, however, will understand that any arrangement of the lighting elements 152a,b,c that facilitates tracking of the gesture controllers 150 (i.e., the position of the horizontal lighting element 152a) and/or determination of the click state (i.e., whether the vertical lighting element 152b is toggled on or off)

The Lighting Element Pattern

A horizontal lighting element 152a that emits, for example, the colour green is preferably always on for the system 100 to identify the location (alternately position) of the cursor 156, while a vertical lighting element 152c that emits, for example, the colour green is preferably toggled, for example, via a button to identify click states.

In preferable embodiments, the distance between the vertical lighting element 152c and a lighting element 152b that emits the colour red is greater than the distance between the horizontal lighting element 152a and the red lighting element 152b, as shown in FIG. 58. This configuration preferably avoids motion or camera blur confusion when searching for click states using the vertical lighting element 152c. Persons skilled in the art will understand that colours other than red and green may be used for the lighting elements 152, and that it is the combination of colour (preferably two colours) that facilitate the tracking and click-state according to the present invention.

The foregoing lighting element pattern is preferably tracked by the process 303 per image frame as follows:

(1) Computer vision framework function to find the contours of every red object;
a. Contours are a series of lines drawn around the object(s);
b. No hierarchy of contours within contours is stored (hierarchyR is left empty);
   i. Parameter involved: RETR_{—} TREE
c. Horizontal, vertical, and diagonal lines compressed into endpoints such that a rectangular contour object is encoded by four points
   i. Parameter involved: CHAIN_APPROX_SIMPLE
d. Contours stored in a vector of a vector of points
   i. vector<vector<Point>> contoursR (as an example).

(2) Check each contour found for whether or not it could be a potential cursor. For each contour:
a. Get contour moments stored in a vector of computer vision framework Moment objects
   i. vector<Moments> momentsR(contoursR.size( ));
b. Get area enclosed by the contour
   i. Area is the zero-th moment
   ii. int area=momentsR[i].m00;
c. Get mass center (x, y) coordinates of the contour
   i. Divide the first and second moments by the zero-th moment to obtain the y and x coordinates, respectively
   ii. massCentersR[i] Point2f(momentsR[i]m10/momentsR[i].m00, momentsR[i].m01/momentsR[i].m00;
d. Check if area is greater than specified minimum area (approximately fifteen) and less than specified maximum area (approximately four hundred) to avoid processing any further if the contour object is too small or too large
   i. Get approximate diameter by square rooting the area
   ii. Define a search distance
      1. Search distance for a particular contour proportional to its diameter
   iii. vector<Point> potentialLeft, potentialRight;
   iv. Search to the left of the central lighting element 152b on the green thresholded matrix to check for the horizontal lighting element 152a to confirm if it is a potential left cursor
      1. Store potential left cursor point in a vector
   v. Search to the right of the central lighting element 152b on the green thresholded matrix to check for the horizontal lighting element 152a to confirm if it is a potential right cursor
      1. Store potential right cursor point in a separate vector

(3) Pick the actual left/right cursor coordinates from the list of potential coordinates
a. Use computations for coordinate output processing to get predicted location
b. Find the potential coordinate that is closest to the predicted location
   i. Minimize: pow(xDiff*xDiff+yDiff*yDiff, 0.5) (“xDiff” being the x distance from the predicted x and a potential x)

(4) Check for left/right click states
a. If a left/right cursor is found
   i. Search upward of the central lighting element 152b on the green thresholded matrix to search for the vertical lighting element 152c to check if a click is occurring

The foregoing process, for each image frame 181b, preferably obtains the following information:

(a) left and right cursor coordinates; and

(b) left and right click states.

The following computer vision framework functions are preferably used for the foregoing process:

(a) “findContours(rImgThresholded, contoursR, hierarchyR, RETR_TREE, CHAIN_APPROX_SIMPLE, Point (0, 0))”; and

(b) “momentsR[i] moments(contoursR[i], false)”.

Post Process Step

The post process step 304 preferably comprises further computations, after the left and right cursor coordinates with click states have been obtained, to refine the cursor tracking algorithm 802a,b output.

Further computations preferably include:

(1) Cursor position prediction substep
a. The cursor position prediction substep 312, using the cursor position prediction algorithm 807a,b, is preferably applied when a new coordinate is found and added;

(2) Jitter reduction substep
a. The jitter reduction substep 313, using the jitter reduction algorithm 808a,b, is preferably applied when a new coordinate is found and added (after the cursor position prediction substep 312 is conducted);

(3) Wide field of view or fish-eye correction substep
a. The wide field of view substep 314, using the fish-eye correction algorithm 809a,b, is preferably applied to the current coordinate. This substep 314 preferably does not affect any stored previous coordinates;

(4) Click state stabilization substep
a. The click state stabilization substep 315, using the click state stabilization algorithm 810a,b, is preferably applied to every frame; and

(5) Search area optimization substep
a. The search area optimization substep 316, using the search area optimization algorithm 811a,b, is preferably applied when searching for the cursor 156.

Information Storage

In preferable embodiments, a cursor position database 81 is used to store information about a cursor (left or right) 156 to perform post-processing computations.

Stored information preferably includes:

(a) amountOfHistory=5;

(b) Click states for the previous amountOfHistory click states;

(c) Cursor coordinates for the previous amountOfHistory coordinates;

(d) Predictive offset (i.e., the vector extending from the current cursor point to the predicted cursor point);

(e) Prediction coordinate;

(f) Focal distance; and

(g) Skipped frames (number of frames for which the cursor has not been found but is still considered to be active and tracked).

Preferably, the maximum number of skipped frames is predetermined—for example, ten. After the predetermined maximum number of skipped frames is achieved, the algorithm 802a,b determines that the physical cursor/LED is no longer in the view of the optical sensor or camera and should halt tracking.

Coordinate Output Processing

Processing on the coordinate output includes application of the cursor position prediction substep 312, the jitter reduction substep 313, the fish-eye correction substep 314, the click state stabilization substep 315, and the search area optimization substep 316.

(1) Cursor Position Prediction Substep

The cursor position prediction substep 312, using the cursor position prediction algorithm 807a,b, preferably facilitates the selection of a cursor coordinate from a list of potential cursor coordinates. In preferable embodiments, the cursor position prediction substep 312 also adjusts for minor or incremental latency produced by the jitter reduction substep 313.

The cursor position prediction substep 312 is preferably linear. In preferable embodiments, the substep 312 takes the last amountOfHistory coordinates and finds the average velocity of the cursor 156 in pixels per frame. The average pixel per frame velocity vector (i.e., the predictive offset) can then preferably be added to the current cursor position to give a prediction of the next position.

In preferable embodiments, to find the average velocity of the cursor 156, the dx and dy values calculated are the sum of the differences between each consecutive previous values for the x and y coordinates, respectively. The C++ code for adding previous data values to find dx and dy values for position prediction is preferably, for example: “for (int i=1; i<previousData.size( )—1 && i<predictionPower; i++); dx+=previousData[i]. x−previousData[i+1].x; dy+=previousData[i].y−previousData[i+1].y”, which can preferably also be described by the following pseudo-code: “For each previous cursor coordinate: add (currentCoordinateIndex.x−previousCoordinateIndex.x) to dx; add (currentCoordinateIndex.y−previousCoordinateIndex.y) to dy”. The foregoing values are then preferably divided by the number of frames taken into account to find the prediction.

(2) Jitter Reduction Substep

In preferable embodiments, the jitter reduction substep 313, using the jitter reduction algorithm 808a,b, reduces noisy input images 180 and/or thresholded images 181b. The jitter reduction substep 313 preferably involves averaging the three most recent coordinates for the cursor. The exemplary C++ code for the jitter reduction algorithm 808a,b, by averaging previous coordinates is preferably, for example: “for (int i=0; i<previousData.size( )&& i<smoothingPower; i++); sumX+=previousData[i].x; sumY+=previousData[i].y; count++”. However, the jitter reduction substep 313 may create a feel of latency between the optical sensor 24 input and cursor 156 movement for the user 10. Any such latency may preferably be countered by applying the cursor prediction substep 312 before the jitter reduction substep 313.

(3) Wide Field of View or Fish-Eye Correction Substep

The wide field of view or fish-eye correction substep 314 (alternately distortion correction 314), using the fish-eye correction algorithm 809a,b, is preferably performed on the outputted cursor coordinates to account for any distortion that may arise, not the input image 180 or the previous data points themselves. Avoiding image transformation may preferably benefit the speed of the algorithm 809a,b. While there may be variations on the fish-eye correction algorithm 809a,b, one preferable algorithm 809a,b used in tracking the lighting elements 152 of the present invention may be:

“Point Cursor::fisheyeCorrection(int width, int height, Point point, int fD)

double nX=point.x−(width/2);

double nY=point.y−(height/2);

double xS=nX/fabs(nX);

double yS=nY/fabs(nY);

nX=fabs(nX);

nY=fabs(nY);

double realDistX=fD*tan(2*a sin(nX/fD));

double realDistY=fD*tan(2*a sin(nY/fD));

realDistX=yS*realDistX+(width/2));

realDistY yS*realDistY+(height/2));

if (point.x !=width*0.5){point.x=(int) realDistX;}

if (point.y !=height*0.5){pointy (int) realDistY;}

return point”

(4) Click State Stabilization Substep

The click state stabilization substep 315, using the click state stabilization algorithm 810a,b, may preferably be applied if a click fails to be detected for a predetermined number of frames (e.g., three) due to, for example, blur from the optical sensor 24 during fast movement. If the cursor 156 unclicks during those predetermined number of frames then resumes, the user experience may be significantly impacted. This may be an issue particularly when the user 10 is performing a drag and drop application.

Preferably, the algorithm 810a,b changes the outputted (final) click state only if the previous amountOfHistory click states are all the same. Therefore, a user 10 may turn off the click lighting element 152, but the action will preferably only be registered amountOfHistory frames later. Although this may create a latency, it prevents the aforementioned disadvantage, a trade-off that this algorithm 810a,b takes. Therefore, previous click states are preferably stored for the purpose of click stabilization.

(5) Search Area Optimization Substep

As previously mentioned, the more pixels that have to be processed, the slower the program will be. Therefore, in preferable embodiments, the area searched on the input image 180 or thresholded image 181b—by the search area optimization 316 using the search area optimization algorithm 811a,b—is optimized by further cropping the cropped image 181a so that the tracked lighting elements 152 will preferably appear in the further cropped region. In the computer vision framework, this crop may be known as setting the “Region of Interest” (ROI).

To build this ROI, two corner points are preferably defined: the top left point 316a and bottom right point 316b, as illustrated in FIG. 59. The substep 316 for estimating a search area can preferably be described by the following pseudo-code (given per image frame):

(1) Get left and right cursor coordinates and their respective predictive offsets
a. Coordinate Output Processing
(2) Find the maximum predictive offset, with a minimum value in case the predictive offsets (refer to Coordinate Output Processing) are 0.
a. A multiplier is needed in case the cursor is accelerating
b. int offsetAmount=multiplier*max(leftCursorOffset.x, max(leftCursorOffset.y, max(rightCursorOffset.x, max(rightCursorOffset.y, minimum))));

(3) Use cursor coordinates to find coordinates of the two corners of the crop rectangle
a. If only a single cursor is found (FIG. 59)
   i. Take that cursor's coordinates as the center of the crop rectangle
b. If both cursors are found
   i. Take (lowest x value, lowest y value) and (highest x value, highest y value) to be the corner coordinates

(4) Apply the offset value found in step 2
a. Subtract/add the offset in the x and y direction for the two corner points
b. If any coordinate goes below zero or above the maximum image dimensions, set the corner to either zero or the maximum image dimension

(5) Return the computer vision framework rectangle (FIG. 59)

a. Rect area(topLeft.x, topLeft.y, bottomRight.x-topLeft.x, bottomRight.y-topLeft.y);

In reducing the search area, the algorithm 811a,b is greatly sped up. However, if a new cursor 156 were to appear at this point, it would not be tracked unless it (unlikely) appeared within the cropped region. Therefore, every predetermined number of frames (e.g., three frames), the full image must still be analyzed in order to account for the appearance of a second cursor.

As a further optimization, if no cursors 156 are found, then the search area optimization substep 316 preferably involves a lazy tracking mode that only processes at a predetermined interval (e.g., every five frames).

The computer readable medium 169, shown in FIG. 2, stores executable instructions which, upon execution, generates a spatial representation in a virtual environment 56 comprising objects using spatial data 170 generated by a gesture controller 150 and corresponding to a position of an aspect of a user 10. The executable instructions include processor instructions 801a, 801b, 802a, 802b, 803a, 803b, 804a, 804b, 805a, 805b, 806a, 806b, 807a, 807b, 808a, 808b, 809a, 809b, 810a, 810b, 811a, 811b for the processors 167 to, according to the invention, perform the aforesaid method 300 and perform steps and provide functionality as otherwise described above and elsewhere herein. The processors 167 encoded by the computer readable medium 169 are such as to collect the spatial data 170 generated by the gesture controller 150, automatically process the spatial data 170 to generate the spatial representation 156 in the virtual environment 56 corresponding to the position of an aspect of the user 10. Thus, according to the invention, the computer readable medium 169 facilitates the user 10 interacting with the objects in the virtual environment 56 using the spatial representation 156 of the gesture controller 150 based on the position of the aspect of the user 10.

Examples of Real World Applications

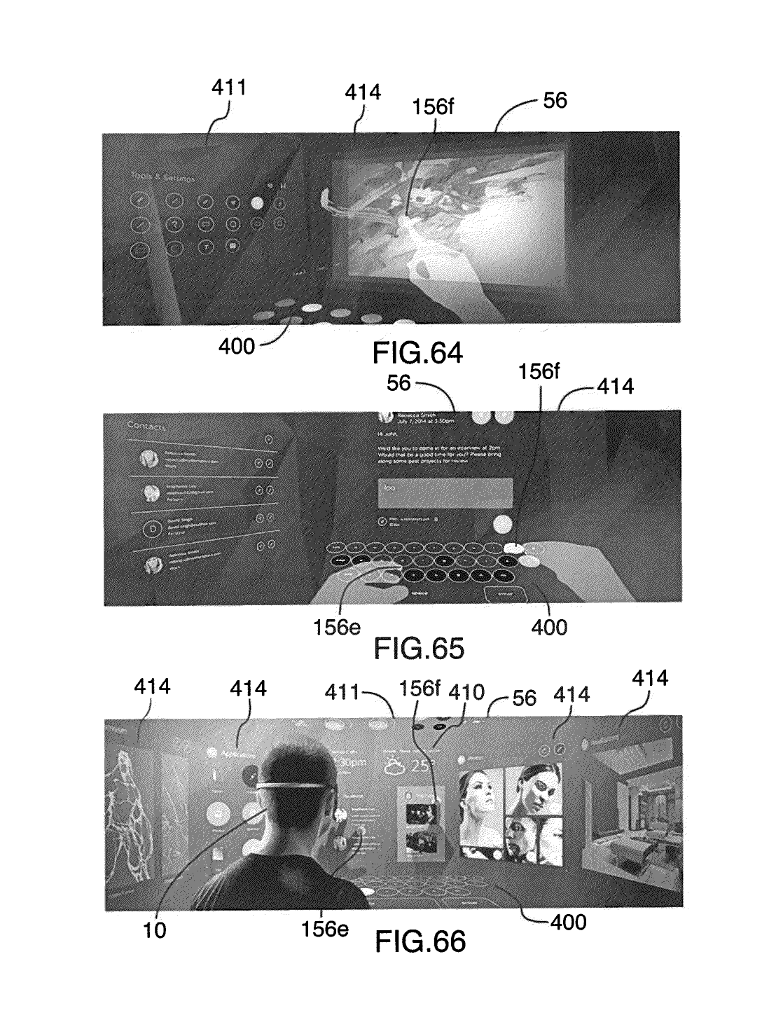

As illustrated in FIGS. 32 and 62-65, applications 30 that may be used with the system 100 preferably comprise: spatial multi-tasking interfaces (FIG. 32A); three dimensional modeling, for example, in architectural planning and design (FIG. 32B); augmented reality (FIG. 32C); three-dimensional object manipulation and modeling (FIG. 32D); virtual reality games (FIG. 32E); internet searching (FIG. 62); maps (FIG. 63); painting (FIG. 64); and text-based communication (FIG. 65).

The above description is meant to be exemplary only, and one skilled in the art will recognize that changes may be made to the embodiments described without departing from the scope of the invention disclosed. Modifications which fall within the scope of the present invention will be apparent to those skilled in the art, in light of a review of this disclosure, and such modifications are intended to fall within the appended claims.

This concludes the description of presently preferred embodiments of the invention. The foregoing description has been presented for the purpose of illustration and is not intended to be exhaustive of to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only by the claims forming a part hereof.

The embodiments for which an exclusive privilege or property is claimed are as follows:

1. A system for a user to interact with a virtual environment comprising objects, wherein the system comprises:
(a) a gesture controller, associated with an aspect of the user, and operative to generate spatial data corresponding to the position of the aspect of the user; and
(b) a mobile device comprising a device processor operative to receive the spatial data of the gesture controller and to automatically process the spatial data to generate a spatial representation in the virtual environment corresponding to the position of the aspect of the user;
whereby the system is operative to facilitate the user interacting with the objects in the virtual environment using the spatial representation of the gesture controller based on the position of the aspect of the user.

2. The system of claim 1, wherein the spatial data comprises accelerometer data, gyroscope data, manometer data, vibration data, and/or visual data.

3. The system of claim 2, wherein the gesture controller comprises a lighting element configured to generate the visual data.

4. The system of claim 3, wherein the lighting element comprises a horizontal light and a vertical light.

5. The system of claim 4, wherein the lighting elements are a predetermined colour.

6. The system of claim 4, wherein the visual data comprises one or more input images.

7. The system of claim 6, wherein the mobile device further comprises an optical sensor for receiving the one or more input images.

8. The system of claim 7, wherein the device processor is operative to generate one or more processed images by automatically processing the one or more input images using cropping, thresholding, erosion and/or dilation.

9. The system of claim 8, wherein the device processor is operative to determine a position of the aspect of the user by identifying the position of the horizontal light using the one or more processed images and determine a position of the spatial representation of the gesture controller within the virtual environment based on the position of the aspect of the user.

10. The system of claim 1, further comprising an enclosure to position the mobile device for viewing by the user.

11. The system of claim 1, comprising four gesture controllers.

12. The system of claim 1, comprising two gesture controllers.

13. The system of claim 9, wherein the device processor is operative to facilitate the user interacting with the objects in the virtual environment by using the spatial representation of the gesture controller to select objects within the aforesaid virtual environment.

14. The system of claim 13, wherein the device processor is operative to determine a selection of objects within the aforesaid virtual environment by identifying the status of the vertical light using the one or more processed images.

15. A method for a user to interact with a virtual environment comprising objects, wherein the method comprises the steps of:
(a) operating a gesture controller, associated with an aspect of the user, to generate spatial data corresponding to the position of the gesture controller; and
(b) operating a device processor of a mobile device to electronically receive the spatial data from the gesture controller and to automatically process the spatial data to generate a spatial representation in the virtual environment corresponding to the position of the aspect of the user;
whereby the method operatively facilitates the user interacting with the objects in the virtual environment using the spatial representation of the gesture controller based on the position of the aspect of the user.

16. The method of claim 15, wherein in step (a), the spatial data comprises accelerometer data, gyroscope data, manometer data, vibration data, and/or visual data.

17. The method of claim 16, wherein in step (a), the gesture controller comprises lighting elements configured to generate the visual data.

18. The method of claim 17, wherein in step (a), the lighting elements comprise a horizontal light and a vertical light.

19. The method of claim 18, wherein in step (a), the lighting elements are a predetermined colour.

20. The method of claim 18, wherein in step (a), the visual data comprises one or more input images.

21. The method of claim 20, wherein in step (b), the mobile device further comprises an optical sensor for receiving the one or more input images.

22. The method of claim 21, wherein in step (b), the device processor is further operative to generate one or more processed images by automatically processing the one or more input images using a cropping substep, a thresholding substep, an erosion substep and/or a dilation substep.

23. The method of claim 22, wherein in step (b), the device processor is operative to (i) determine a position of the aspect of the user by identifying the position of the horizontal light using the one or more processed images, and (ii) determine a position of the spatial representation of the gesture controller within the virtual environment based on the position of the aspect of the user.

24. The method of claim 15, further comprising a step of positioning the mobile device for viewing by the user using an enclosure.

25. The method of claim 15, wherein step (a) comprises four gesture controllers.

26. The method of claim 15, wherein step (a) comprises two gesture controllers.

27. The method of claim 23, further comprising a step of (c) operating the device processor to facilitate the user interacting with the objects in the virtual environment by using the spatial representation of the gesture controller to select objects within the aforesaid virtual environment.

28. The method of claim 27, wherein in step (c), the selection of objects within the aforesaid virtual environment is determined by identifying the status of the vertical light using the one or more processed images.

29. A gesture controller for generating spatial data associated with an aspect of a user for use with objects in a virtual environment provided by a mobile device processor which electronically receives the spatial data from the gesture controller, wherein the gesture controller comprises:
(a) an attachment member to associate the gesture controller with the user; and
(b) a controller sensor operative to generate the spatial data associated with the aspect of the user;
whereby the gesture controller is operative to facilitate the user interacting with the objects in the virtual environment.

30. The gesture controller of claim 29, wherein the controller sensor comprises an accelerometer, a gyroscope, a manometer, a vibration component and/or a lighting element.

31. The gesture controller of claim 30, wherein the controller sensor is a lighting element configured to generate visual data.

32. The gesture controller of claim 31, wherein the lighting element comprises a horizontal light, a vertical light and a central light.

33. The gesture controller of claim 32, wherein the horizontal light, the vertical light and the central light are arranged in an L-shaped pattern.

34. The gesture controller of claim 31, wherein the lighting elements are a predetermined colour.

35. The gesture controller of claim 34, wherein the predetermined colour is red and/or green.

36. The gesture controller of claim 29, wherein the attachment member is associated with the hands of the user.

37. The gesture controller of claim 36, wherein the attachment member is elliptical in shape.

38. The gesture controller of claim 36, wherein the attachment member is shaped like a ring.

39. A computer readable medium on which is physically stored executable instructions which, upon execution, will generate a spatial representation in a virtual environment comprising objects using spatial data generated by a gesture controller and corresponding to a position of an aspect of a user, wherein the executable instructions comprise processor instructions for a device processor to automatically:
(a) collect the spatial data generated by the gesture controller; and
(b) automatically process the spatial data to generate the spatial representation in the virtual environment corresponding to the position of the aspect of the user;
to thus operatively facilitate the user interacting with the objects in the virtual environment using the spatial representation of the gesture controller based on the position of the aspect of the user.
